(19) United States
(12) Patent Application Publication
(10) Pub. No.: US 2026/0343534 A1
(43) Pub. Date: Oct. 29, 2026

(54) TERMINAL, RADIO COMMUNICATION METHOD, AND BASE STATION

(71) Applicant: NTT DOCOMO, INC., Tokyo (JP)

(72) Inventors: Yuki Matsumura, Chiyoda-ku, Tokyo (JP); Naoya Shibaike, Chiyoda-ku, Tokyo (JP); Satoshi Nagata, Chiyoda-ku, Tokyo (JP); Jing Wang, Haidian District, Beijing (CN); Lan Chen, Haidian District, Beijing (CN)

(73) Assignee: NTT DOCOMO, INC., Tokyo (JP)

(21) Appl. No.: 19/486,844

(22) PCT Filed: Jun. 21, 2023
(86) PCT No.: PCT/JP2023/022985

§ 371 Date: Nov. 21, 2025

(51) Int. Cl. H04W 72/1268; H04W 72/232

(52) U.S. Cl. CPC H04W 72/1268; H04W 72/232

(57) ABSTRACT

A terminal according to one aspect of the present disclosure includes a receiving section that receives downlink control information to be used for scheduling a physical uplink shared channel (PUSCH), and a control section that controls, based on information on a rank of the PUSCH and information on whether an uplink shared channel (UL-SCH) is transmitted or not included in the downlink control information, a transmission of the UL-SCH and channel state information in one or more codewords (CWs) corresponding to the PUSCH.

### TECHNICAL FIELD

The present disclosure relates to a terminal, a radio communication method, and a base station in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (see Non-Patent Literature 1). In addition, for the purpose of further high capacity, advancement and the like of the LTE (Third Generation Partnership Project (3GPP (registered trademark)) Release (Rel.) 8 and Rel. 9), the specifications of LTE-Advanced (3GPP Rel. 10 to Rel. 14) have been drafted.

Successor systems of LTE (for example, also referred to as “5th generation mobile communication system (5G),” “5G+ (plus),” “6th generation mobile communication system (6G),” “New Radio (NR),” “3GPP Rel. 15 (or later versions),” and so on) are also under study.

### CITATION LIST

### Non-Patent Literature

Non-Patent Literature 1:3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

In Rel-15 NR, an uplink (UL) Multi Input Multi Output (MIMO) transmission with up to four layers is supported. For future NRs, a UL transmission with the number of layers larger than four is under study to be supported to realize a higher spectrum efficiency. For example, for Rel-18 NR, a transmission with up to six ranks using six antenna ports and a transmission with up to six or eight ranks using eight antenna ports are under study.

In Rel-18 NR and later versions, a case in which a transmission/scheduling of a plurality of (for example, two or more) codewords/transport blocks is supported is also assumed for the UL transmission (for example, a PUSCH transmission) using the number of layers/ranks larger than four.

However, in a case in which the transmission/scheduling of the plurality of codewords/transport blocks is supported for the UL transmission using the number of layers/ranks larger than four, how to control the UL transmission has not been sufficiently studied.

In view of this, an object of the present disclosure is to provide a terminal, a radio communication method and a base station that can appropriately control the UL transmission using more than four antenna ports.

### Solution to Problem

A terminal according to one aspect of the present disclosure includes: a receiving section that receives downlink control information to be used for scheduling a physical uplink shared channel (PUSCH); and a control section that controls, based on information on a rank of the PUSCH and information on whether an uplink shared channel (UL-SCH) is transmitted or not included in the downlink control information, a transmission of the UL-SCH and channel state information in one or more codewords (CWs) corresponding to the PUSCH.

### Advantageous Effects of Invention

According to one aspect of the present disclosure, a UL transmission using more than four antenna ports can be appropriately controlled.

### BRIEF DESCRIPTION OF DRAWINGS

FIG. 1 is a diagram to show an example of a correspondence relation between a field value of precoding information and the number of layers, and the number of layers and a TPMI in Rel-16 NR.

FIGS. 2A to 2C are diagrams to show an SRI indication or a second SRI indication during a codebook-based PUSCH transmission in Rel. 17.

FIG. 3 is a diagram to show an example of an antenna layout for eight antenna ports.

FIG. 4 is a diagram to show an example of transmission control of a PUSCH according to a first embodiment.

FIG. 5 is a diagram to show another example of the transmission control of the PUSCH according to the first embodiment.

FIG. 6 is a diagram to show another example of the transmission control of the PUSCH according to the first embodiment.

FIG. 7 is a diagram to show another example of the transmission control of the PUSCH according to the first embodiment.

FIG. 8 is a diagram to show an example of the transmission control of the PUSCH according to a second embodiment.

FIG. 9 is a diagram to show another example of the transmission control of the PUSCH according to the second embodiment.

FIG. 10 is a diagram to show another example of the transmission control of the PUSCH according to the second embodiment.

FIG. 11 is a diagram to show an example of a schematic configuration of a radio communication system according to one embodiment.

FIG. 12 is a diagram to show an example of a configuration of a base station according to one embodiment.

FIG. 13 is a diagram to show an example of a configuration of a user terminal according to one embodiment.

FIG. 14 is a diagram to show an example of a hardware configuration of the base station and the user terminal according to one embodiment.

FIG. 15 is a diagram to show an example of a vehicle according to one embodiment.

### DESCRIPTION OF EMBODIMENTS

### Control of Transmission of SRS and PUSCH

In Rel-15 NR, a terminal (user terminal) or user equipment (UE) may receive information that is used to transmit a reference signal for measurement (for example, sounding reference signal (SRS)) (SRS configuration information, for example, a parameter in an “SRS-Config” of an RRC control element).

Specifically, the UE may receive at least one of information on one or more SRS resource sets (SRS resource set information, for example, an “SRS-ResourceSet” of the RRC control element) and information on one or more SRS resources (SRS resource information, for example, an “SRS-Resource”of the RRC control element).

One SRS resource set may be associated with a certain number of SRS resources (a certain number of the SRS resources may be grouped together). Each of the SRS resources may be specified by an SRS resource indicator (SRI) or an SRS resource ID (identifier).

The SRS resource set information may include information on an SRS resource set ID (an SRS-ResourceSetId), a list of the SRS resource IDs (SRS-ResourceIds) that are used in such a resource set, an SRS resource type or a usage of the SRS.

Here, the SRS resource type may indicate any of a periodic SRS (a P-SRS), a semi-persistent SRS (an SP-SRS) or an aperiodic CSI (an Aperiodic SRS (an A-SRS)). Note that the UE may periodically transmit the P-SRS and the SP-SRS (or periodically after activation) and may transmit the A-SRS based on an SRS request of DCI.

The usage (the “usage” of an RRC parameter and an “SRS-SetUse” of an L1 (Layer-1) parameter) may be, for example, beam management (a beamManagement), a codebook (a CB), a noncodebook (an NCB), antenna switching, or the like. The SRS for the codebook or the non-codebook usage may be used to determine a precoder of a codebook-based or non-codebook-based uplink shared channel (Physical Uplink Shared Channel (PUSCH)) transmission based on the SRI.

For example, the UE, in a case of a codebook-based transmission, may determine the precoder (a precoding matrix) for a PUSCH transmission based on the SRI, a transmission rank indicator (TRI) and a transmitted precoding matrix indicator (TPMI). The UE, in the case of non-codebook-based transmission, may determine the precoder for the PUSCH transmission based on the SRI.

The SRS resource information may include the SRS resource ID (the SRS-ResourceId), the number of SRS ports, an SRS port no., a transmission Comb, an SRS resource mapping (for example, a time and/or frequency resource location, a resource offset, a period of a resource, the number of repetitions, the number of SRS symbols or an SRS bandwidth), hopping relation information, the SRS resource type, a series ID, spatial relation information on the SRS, or the like.

The spatial relation information on the SRS (for example, a “spatialRelationInfo” of an RRC information element) may indicate the spatial relation information between a certain reference signal and the SRS, Such a certain reference signal may be at least one of a synchronization signal/broadcast channel (Synchronization Signal/Physical Broadcast Channel (an SS/a PBCH)) block, a channel state information reference signal (a CSI-RS) and the SRS (for example, another SRS). The SS/PBCH block may be referred to as a synchronization signal block (an SSB).

The spatial relation information on the SRS may include at least one of an SSB index, a CSI-RS resource ID and the SRS resource ID as an index of the certain reference signal described above.

Note that in the present disclosure, SSB Index, SSB resource ID and SSB resource indicator (SSBRI) may be read interchangeably with one another. CSI-RS index, CSI-RS resource ID and CSI-RS resource indicator (CRI) may also be read interchangeably with one another. SRS index, SRS resource ID and SRI may also be read interchangeably with one another.

The spatial relation information on the SRS may include a serving cell index, a BWP index (a BWP ID), or the like that corresponds to the certain reference signal described above.

In a case in which the spatial relation information on the SSB or the CSI-RS and the SRS is configured for a certain SRS resource, the UE may transmit such an SRS resource using the same spatial domain filter (a spatial domain transmission filter) as a spatial domain filter (a spatial domain reception filter) for a reception of such an SSB or CSI-RS. In this case, the UE may assume that a UE reception beam of the SSB or the CSI-RS and a UE transmission beam of the SRS are the same.

In a case in which the spatial relation information on another SRS (a reference SRS) and such an SRS (a target SRS) is configured for a certain SRS (the target SRS) resource, the UE may transmit the target SRS resource using the same spatial domain filter (the spatial domain transmission filter) as the spatial domain filter (the spatial domain transmission filter) for the transmission of such a reference SRS. In other words, in this case, the UE may assume that the UE transmission beam of the reference SRS and the UE transmission beam of the target SRS are the same.

The UE may determine the spatial relation of the PUSCH that is to be scheduled by such DCI based on a value of a certain field (for example, an SRS resource indicator (SRI) field) in the DCI (for example, DCI format 0_1). Specifically, the UE may use the spatial relation information on the SRS resource that is to be determined based on the value of such a certain field (for example, the SRI) (for example, the “spatialRelationInfo” of the RRC information element) for the PUSCH transmission.

In Rel-15/16 NR, in a case in which the codebook-based transmission is used for the PUSCH, the UE may be configured with the SRS resource set with the usage of the codebook including up to two SRS resources by the RRC and may be indicated with one of such up to two SRS resources by the DCI (a 1-bit SRI field). A transmission beam of the PUSCH will be indicated by the SRI field.

The UE may determine the TPMI and the number of layers (a transmission rank) for the PUSCH based on precoding information and a number of layers field (hereinafter also referred to as a precoding information field). The UE may select the precoder from the codebook for an uplink with respect to the same number of ports as the number of SRS ports indicated by a “nrofSRS-Ports” of a higher layer parameter that is configured for the SRS resource indicated by the SRI field described above, based on the TPMI, the number of layers, or the like described above.

In Rel-15/16 NR, in a case in which the non-codebook-based transmission is used for the PUSCH, the UE may be configured with the SRS resource set with the usage of the noncodebook including up to four SRS resources by the RRC and may be indicated with one or more of such up to four SRS resources by the DCI (a 2-bit SRT field).

The UE may determine the number of layers (the transmission rank) for the PUSCH based on the SRI field described above. For example, the UE may determine that the number of SRS resources indicated by the SRI field described above and the number of layers for the PUSCH are the same. The UE may also calculate the precoder of the SRS resource described above.

In a case in which the CSI-RS that is associated with such an SRS resource (or the SRS resource set to which such an SRS resource belongs), which may be referred to as an associated CSI-RS, is configured in the higher layer, the transmission beam of the PUSCH may be calculated based on (the measurement of) such an associated CSI-RS that is configured. Otherwise, the transmission beam of the PUSCH may be indicated by the SRI.

Note that the UE may be configured whether to use a codebook-based PUSCH transmission or a non-codebook-based PUSCH transmission by a higher layer parameter “txConfig,” which indicates a transmission scheme. Such a parameter may indicate the value of the “codebook” or the “noncodebook (a nonCodebook).”

In the present disclosure, a codebook-based PUSCH (the codebook-based PUSCH transmission, the codebook-based transmission) may mean the PUSCH in a case in which the UE is configured with the “codebook” as the transmission scheme. In the present disclosure, a non-codebook-based PUSCH (the non-codebook-based PUSCH transmission, the non-codebook-based transmission) may mean the PUSCH in a case in which the UE is configured with the “noncodebook” as the transmission scheme.

### Determination of PUSCH Precoder for Codebook (CB)-Based Transmission

As described above, the UE may determine the precoder for the PUSCH transmission based on the SRI, the TRI, the TPMI, or the like in the case of codebook (CB)-based transmission.

The SRI, the TRI, the TPMI, or the like may be notified to the UE using the downlink control information (DCI). The SRI may be indicated by the SRS Resource Indicator field (the SRI field) of the DCI or may be indicated by a parameter “srs-ResourceIndicator” included in the RRC information element “ConfiguredGrantConfig” of a configured grant PUSCH.

The TRI and the TPMI may be indicated by the precoding information and the number of layers field of the DCI. The precoding information and the number of layers field are also referred to as the precoding information field for simplicity.

The UE may report UE capability information on a precoder type and may be configured with the precoder type based on such UE capability information by the higher layer signaling from a base station. Such UE capability information may be information on the precoder type to be used for the PUSCH transmission by the UE (for example, it may be represented by an RRC parameter “pusch-TransCoherence”).

The UE may determine the precoder to be used for the PUSCH transmission based on the information on the precoder type (for example, an RRC parameter “codebookSubset”) that is included in PUSCH configuration information notified by the higher layer signaling (for example, a “PUSCH-Config” information element of an RRC signaling). The UE may be configured with a subset of a PMI to be indicated by the TPMI by the codebookSubset.

Note that the precoder type may be indicated by any one of a full coherent (a fully coherent), a partial coherent and a non coherent, or a combination of at least two of these (for example, it may be represented by a parameter such as a “full and partial and non coherent (a fullyAndPartialAndNonCoherent)” or a “partial and non coherent (a partialAndNonCoherent)”).

For example, the RRC parameter “pusch-TransCoherence, ” which indicates the UE capability, may indicate the full coherent (a fullCoherent), the partial coherent (a partialCoherent) or the non coherent (a nonCoherent). The RRC parameter “codebookSubset” may indicate the “full and partial and non coherent (the fullyAndPartialAndNonCoherent),” the “partial and non coherent (the partialAndNonCoherent)” or the “non coherent (the nonCoherent)”.

The full coherent may mean that all antenna ports to be used for the transmission are synchronized, which may be represented as being able to match their phases, being able to control a phase for each coherent antenna port or being able to apply the precoder appropriately for each coherent antenna port. The partial coherent may mean that some ports of the antenna ports to be used for the transmission are synchronized with one another, while such some ports are not synchronized with the other ports. The non coherent may mean that each antenna port to be used for the transmission cannot be synchronized.

Note that the UE that supports the precoder type of the full coherent may be assumed to support the precoder type of the partial coherent and the non coherent. The UE that supports the precoder type of the partial coherent may be assumed to support the precoder type of the non coherent.

In the present disclosure, precoder type, coherency, PUSCH transmission coherence, coherent type, coherence type, codebook type, codebook subset, codebook subset type, and the like may be read interchangeably with one another.

The UE may determine a precoding matrix that corresponds to a TPMI index to be obtained from the DCI scheduling a UL transmission (for example, DCI format 0_1, similarly hereinafter) from among a plurality of precoders, which may also be referred to as precoding matrices, codebooks, or the like, for the CB-based transmission.

### Precoding Information Field

The UE may determine the TPMI and the number of layers (the transmission rank) for such a PUSCH based on the precoding information field of the DCI that schedules the PUSCH (for example, DCI format 0_1/0_2).

With respect to the codebook-based PUSCH, the number of bits in the precoding information field may be determined (may vary) based on a configuration of whether a transform precoder for the PUSCH is enabled or disabled (for example, a higher layer parameter transformPrecoder), a configuration of the codebook subset for the PUSCH (for example, the higher layer parameter codebookSubset), a configuration of the maximum number of layers for the PUSCH (for example, a higher layer parameter maxRank), a configuration of an uplink full-power transmission for the PUSCH (for example, a higher layer parameter ul-FullPowerTransmission), the number of antenna ports for the PUSCH, or the like.

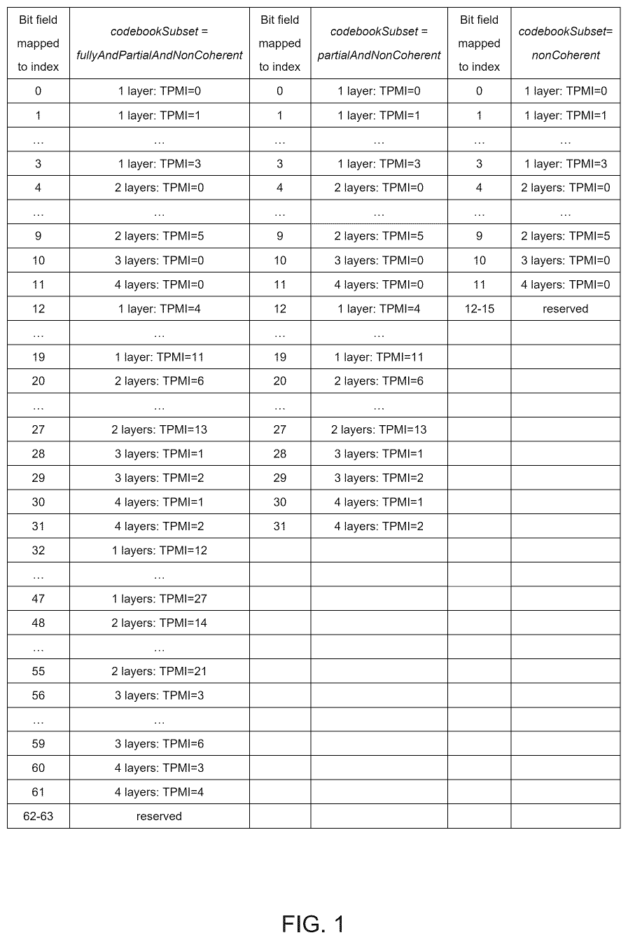

FIG. 1 is a diagram to show an example of a correspondence relation between a field value of the precoding information and the number of layers, and the number of layers and the TPMI in Rel-16 NR. The correspondence relation in the present example is for four antenna ports in a case in which the transform precoder is configured to be disabled, a maximum rank (the maxRank) is configured to be two, three or four, and the uplink full-power transmission is not configured or is configured to be full-power mode 2 (fullpowerMode2) or full-power (fullpower), but is not limited to this. Note that it is obviously understood by those skilled in the art that a “bit field mapped to an index” as illustrated indicates the field value of the precoding information and the number of layers.

In FIG. 1, the precoding information field is 6 bits in a case in which the UE is configured with the codebook subset of the full coherent (the fullyAndPartialAndNonCoherent), 5 bits in a case in which the UE is configured with the codebook subset of the partial coherent (the partialAndNonCoherent) or 4 bits in a case in which the UE is configured with the codebook subset of the non coherent (the nonCoherent).

Note that, as shown in FIG. 1, the number of layers and the TPMI that correspond to the value of a certain precoding information field may be the same (common), regardless of the codebook subset to be configured for the UE. For example, in FIG. 1, the number of layers and the TPMI indicated by the value of the precoding information field=0 to 11 may be the same for the codebook subsets of the full coherent (the fullyAndPartialAndNonCoherent), the partial coherent (the partialAndNonCoherent) and the non coherent (the nonCoherent). In FIG. 1, the number of layers and the TPMI indicated by the value of the precoding information field=0 to 31 may be the same for the codebook subsets of the full coherent (the fullyAndPartialAndNonCoherent) and the partial coherent (the partialAndNonCoherent).

Note that the precoding information field may be 0 bits for the non-codebook-based PUSCH. The precoding information field may be 0 bits for the codebook-based PUSCH of one antenna port.

### SRS Configuration of Codebook-Based PUSCH

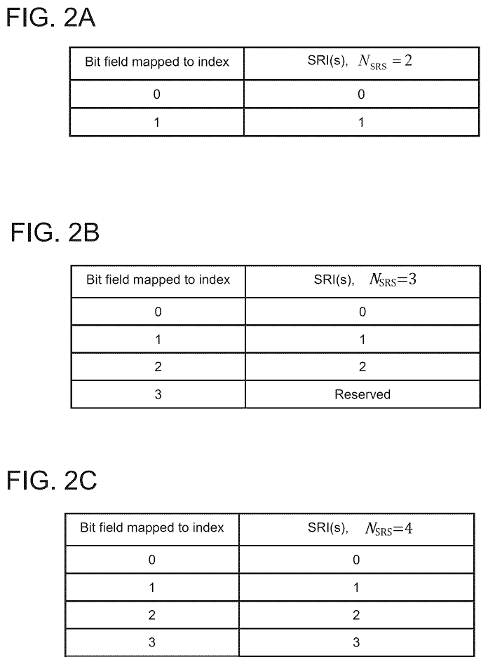

FIG. 2A is a diagram to show an SRI indication or a second SRI indication during the codebook-based PUSCH transmission in a case in which the ul-FullPowerTransmission is not configured, ul-FullPowerTransmission=fullpowerModel, ul-FullPowerTransmission=fullpowerMode2 or ul-FullPowerTransmission=fullpower, and N_{SRS}=2 in Rel. 17. FIG. 2B is a diagram to show the SRI indication or the second SRI indication for the codebook-based PUSCH transmission in a case in which ul-FullPowerTransmission=fullpowerMode2 and N_{SRS}=3 in Rel. 17. FIG. 2C is a diagram to show the SRI indication or the second SRI indication for the codebook-based PUSCH transmission in a case in which ul-FullPowerTransmission=fullpowerMode2 and N_{SRS}=4 in Rel. 17.

The SRI indication corresponds to the SRS resource indicator field of the DCI, while the second SRI indication corresponds to the Second SRS resource indicator field of the DCI. An SRS resource set indicator field is to be 2 bits in a case in which txConfig=nonCodeBook, and two SRS resource sets associated with the usage of the “nonCodeBook” that is configured by an srs-ResourceSetToAddModList exist, or in a case in which txConfig codebook, and two SRS resource sets associated with the usage of the “codebook” that is configured by the srs-ResourceSetToAddModList exist. Otherwise, the SRS resource set indicator field is to be 0 bits.

The SRS resource indicator field is [log₂ (N_{SRS})] bits in a case in which the higher layer parameter txConfig=codebook in accordance with FIGS. 2A to 2C. The N_{SRS} is the number of SRS resources that are configured in the SRS resource set indicated by the SRS resource set indicator field (if present). Otherwise, the N_{SRS} is the number of SRS resources associated with the usage of the higher-level parameter with the value ‘codeBook’ that are configured in the SRS resource set configured by the higher layer parameter srs-ResourceSetToAddModList.

For the codebook-based transmission, the PUSCH is scheduled or semi-fixedly configured by DCI Format 0_0, DCI Format 0_1 or DCI Format 0_2. Only one or two SRS resource sets can be configured in the SRS-ResourceSetToAddModList with the usage “codebook” of the higher layer parameter of the SRS-ResourceSet. Only one or two SRS resource sets can be configured in srs-ResourceSetToAddModListDCI-0-2 with a parameter usage “codebook” of the higher layer of the SRS-ResourceSet.

For the srs-ResourceSetToAddModList or srs-ResourceSetToAddModListDCI-0-2, in a case in which two SRS resource sets are configured by configuring the usage of the higher layer parameter of the SRS-ResourceSet to the “codebook,” one or two SRIs, and one or two TPMIs are provided by two SRS resource indication fields and two precoding information fields, respectively.

The UE applies indicated SRIs and TPMIs to one or more PUSCH repetitions in accordance with the SRS resource set associated with the PUSCH repetitions. In a case in which two SRS resource sets are configured for the SRS-ResourceSetToAddModList or srs-ResourceSetToAddModListDCI-0-2, and the usage of the higher layer parameter of the SRS-ResourceSet is configured to the “codebook,” the UE does not expect different numbers of SRS resources to be configured for the two SRS resource sets.

For the codebook-based transmission, only one SRS resource may be indicated based on the SRI from within the SRS resource set. Except in the case in which the higher layer parameter “ul-FullPowerTransmission” is configured to “fullpowerMode2,” the maximum number of SRS resources configured for the codebook-based transmission is two. In a case in which an aperiodic SRS is configured for the UE, an SRS request field of the DCI triggers a transfer of an aperiodic SRS resource.

Except in the case in which the higher layer parameter “ul-FullPowerTransmission” is configured to “fullpowerMode2,” in a case in which a plurality of SRS resources are configured to the “codebook” by the SRS-ResourceSet, the UE expects that the higher layer parameter “nrofSRS-Port” of the SRS-Resource in the SRS-ResourceSet is configured to the same value for all these SRS resources.

In the case in which the higher layer parameter “ul-FullPowerTransmission” is configured to “fullpowerMode2,” the following (1) through (3) are applied.
(1) The UE can configure one SRS resource, or the plurality of SRS resources including the same or different numbers of SRS ports in the SRS resource set whose usage is configured to the “codebook.”
(2) In a case in which the plurality of SRS resources are configured in the SRS resource set, up to two different spatial relations can be configured for all SRS resources in the SRS resource set whose usage is configured to the “codebook.”
(3) Depending on a capability of the UE, up to two or four SRS resources are to be supported for the SRS resource set whose usage is configured to the “codebook.”

In a case of a normal codebook-based PUSCH, one SRS resource set that includes two SRS resources with the same number of ports can be configured. In a case of a codebook-based PUSCH repetitions (for multi-transmission/reception points (TRPs)), two SRS resource sets with the same number of SRS resources may be configured for each. For a codebook base, in the case of “fullpowerMode2,” one SRS resource set and the SRS resources with the same or different numbers of ports can be configured.

### Transmission of More Than Four Antenna Ports

In Rel-15/16 NR, an uplink (UL) Multi Input Multi Output (MIMO) transmission with up to four layers is supported. For future radio communication systems, the UL transmission with the number of layers larger than four is under study to be supported to realize a higher spectrum efficiency. For example, for Rel-18 NR, a transmission with up to six ranks using six antenna ports and a transmission with up to six or eight ranks using eight antenna ports are under study.

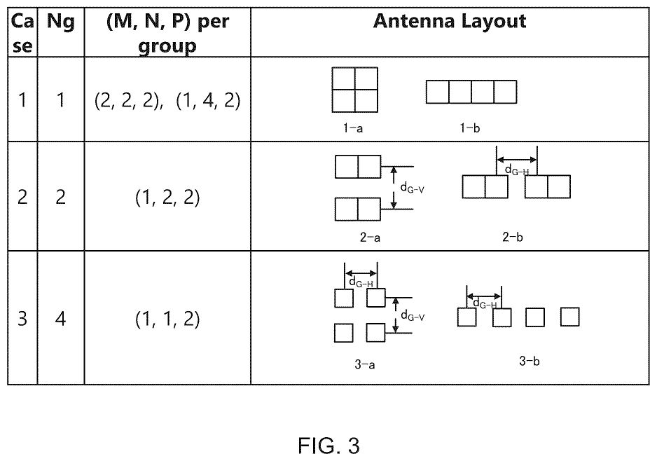

FIG. 3 is a diagram to show an example of an antenna layout for eight antenna ports. An Ng is the number of antenna groups. An M is the number of antennas (or antenna elements) of a first dimension, and an N is the number of antennas (or antenna elements) of a second dimension. The first dimension and the second dimension are, for example, a horizontal direction and a vertical direction. A P is the number of planes of polarization. P=2 means a cross-polarization antenna.

An antenna group may be referred to as a coherent group. The coherent group may include one or more coherent ports. For example, a partial coherent UE may include a plurality of coherent groups. The antenna ports in the coherent group may be mutually coherent. The antenna ports in different coherent groups do not need to be mutually coherent.

Each of the coherent groups may correspond to a different transmission panel/transmission chain (Tx chain)/SRS resource set/RS resource set/spatial relation information (spatial relation info)/joint Transmission Configuration Indication state (joint TCI state)/UL TCI state/reception TRP. Here, the SRS resource set may particularly correspond to the SRS resource set with the usage of the codebook or the noncodebook. Each of the coherent groups may correspond to a different reception TRP. The coherent group may also be referred to as a coherent antenna group, a port group, an antenna set, or the like.

The UE may report the antenna group/antenna deployment information/coherent number it supports as the UE capability information. The UE may be configured with the coherent group (for example, the number of coherent groups or the number of ports included in each of the coherent groups) by the higher layer signaling.

Note that the antenna layout is not limited to the example shown in FIG. 3. For example, the number of panels on which the antennas are deployed, a direction of the panel, coherency of each panel/antenna (full coherent, partial coherent, non coherent, or the like), antenna arrangement in a specific direction (horizontal, vertical, or the like) and a polarization antenna configuration (single polarization, cross-polarization, number of planes of polarization, or the like) may be different from the examples shown in FIGS. 2A and 2B. A dG-H and a dG-V represent a horizontal distance and a vertical distance between centers of adjacent antenna groups, respectively.

While the transmission of one codeword (CW) for one PUSCH is supported in Rel-15/16/17 NR, the UE is under study to transmit more than one CW for one PUSCH for Rel-18 NR. For example, a 2CW/dual CW transmission for the ranks 5 through 8 and the 2CW/dual CW transmission for the ranks 2 through 8 are under study to be supported.

### UL Transmission of the Number of Ranks Larger Than Four/Plurality of Codewords

With respect to the UL transmission, in a case in which the maximum number of ranks to be configured by the RRC (for example, a max configured PUSCH rank) is to be larger than four (for example, eight), the following UL transmission control may be applied.

The maximum number of ranks of the UL transmission (for example, the PUSCH) (for example, a maximum configured PUSCH rank) may be a value reported as the UE capability, regardless of whether it is configured by the RRC.

The following description shows an example in a case in which the maximum configured PUSCH rank (for example, the max configured PUSCH rank) is eight, but the maximum configured PUSCH rank may be another value (for example, five, six or seven).

In the case in which the maximum number of ranks to be configured for the UL transmission is larger than four, a rank range to be indicated by the DCI may be determined based on such a maximum number of ranks. For example, the rank range to be indicated by the DCI (for example, a DCI indicated rank range) may be determined based on at least one of the following options 1 through 2.

### Option 1

With respect to the UL transmission, in the case in which the maximum number of ranks to be configured is larger than four, the rank range to be indicated by the DCI may be a range from one to the maximum number of ranks (for example, one to eight).

A certain field may be applied to the field of the DCI to be applied to a rank indication. For example, in a case in which the codebook-based transmission (for example, a CB-based TX) is applied, the rank/rank range may be indicated by the precoding information and an indication field for the number of layers (for example, a precoding information and number of layers field) included in the DCI.

In a case in which the non-codebook-based transmission (for example, a non-CB-based TX) is applied, the rank/rank range may be indicated by the SRI resource indicator field (for example, the SRI field) included in the DCI.

Supporting the indication of a rank/layer of four or smaller in the case in which the maximum number of ranks to be configured for the UL transmission is larger than four enables the number of ranks/layers that is to be applied to be flexibly controlled, regardless of the maximum rank of the UL transmission.

### Option 2

With respect to the UL transmission, in the case in which the maximum number of ranks to be configured is larger than four, the rank range to be indicated by the DCI may be a sub-range from one to the maximum number of ranks (for example, one to eight). The sub-range may be, for example, a first range (for example, one to four) or a second range (for example, five to eight) . The sub-range may be configured/indicated by the RRC/an MAC CE/the DCI.

In a case in which the sub-range is configured/indicated by the RRC/MAC CE, it may mean that the rank range to be indicated by the DCI is to be configured/indicated by the RRC/MAC CE.

In a case in which the sub-range is indicated by the DCI, it may be indicated explicitly (for example, by an explicit bit indication) or may be indicated implicitly.

In a case in which it is indicated explicitly by the DCI, the sub-range may be indicated, or a specific sub-range may be indicated from among sub-range candidates that are defined in advance.

In a case in which it is indicated implicitly by the DCI, an existing field of the DCI may be applied. For example, the sub-range may be indicated based on the value of a certain field that corresponds to a certain transport block. The certain field may be, for example, at least one of an MCS field, an NDI field and an RV field. In a case in which the certain field is a specific value, it may mean that a specific sub-range is indicated.

The UE capability (for example, the UE capability) with respect to whether the configuration/indication between different ranks/sub-ranges is supported or not may be defined.

### DCI Field in Case in Which the Plurality of CWs/TBs are Supported

In Rel-17 NR and earlier versions, the transmission of two CWs/TBs (for example, TB #1 and TB #2) is supported for a DL transmission (for example, a PDSCH transmission). In a case in which two TBs (for example, TB #2) are supported, each of a certain field for TB #1 and a certain field for TB #2 may be included in the DCI by the DCI to be used for scheduling a PDSCH (for example, DCI format 1_1/1_2). The certain field may be, for example, at least one of a modulation/coding method (Modulation and coding scheme), a new data indicator and a redundancy version.

In the PDSCH transmission, the fact that two TBs are supported (for example, TB #2 exists) may be notified to the UE from the base station by a certain higher layer parameter. The certain higher layer parameter may be the higher layer parameter with respect to the maximum number of codewords to be scheduled by the DCI (for example, a maxNrofCodeWordsScheduledByDCI). The certain higher layer parameter (for example, the maxNrofCodeWordsScheduledByDCI) may be included in a PDSCH configuration (for example, a PDSCH-config).

For example, in a case in which it is configured to be 2 by the certain higher layer parameter (for example, the maxNrofCodeWordsScheduledByDCI equals 2), it may mean that the certain field for TB #2 is included in such DCI. In other words, for the PDSCH, in a case in which the certain higher layer parameter indicates a certain value (for example, 2), it may mean that the field for TB #2 exists (or that a two codeword transmission is enabled).

In a case in which the certain higher layer parameter (for example, the maxNrofCodeWordsScheduledByDCI) indicates that the two codeword transmission (for example, two codeword transmission) is enabled, one of the two transport blocks may be disabled by a DCI format when a certain condition is satisfied. For example, the certain condition may be that each of an MCS index (for example, I_{MCS}) and an RV index is to be a certain value (for example, I_{MCS}=26 and RV=1) for a corresponding transport block.

In this way, if the certain higher layer parameter is configured to a certain value (for example, maxNrofCodeWordsScheduledByDCI=2) and the TB with I_{MCS}=26 and RV=1 exists, a dynamic indication (or switching) between a case with more than four layers and a case with less than four layers for the PDSCH may be realized by disabling the corresponding TB.

In a case in which the PUSCH transmission of the dual CWs with rank >4 is supported by the UE that supports eight transmissions (for example, 8T×UE) in Rel. 18 or later versions, a field of the DCI to be used for scheduling the PUSCH is also assumed to be added.

For example, to support the PUSCH transmission of the dual CWs with rank >4 by the 8T×UE, a second MCS field (for example, 5 bits) is assumed to be supported for a second CW. As an example, the DCI to be used for scheduling the PUSCH (for example, DCI format 0_1/0_2) may include a first MCS field and the second MCS field.

To support the PUSCH transmission of the dual CWs with rank >4 by the 8T×UE, a second set of the NDI (for example, 1 bit) field/RV (for example, 2 bits) field is assumed to be supported. As an example, the DCI to be used for scheduling the PUSCH (for example, DCI format 0_1/0_2) may include a first NDI field/RV field and a second NDI field/RV field.

In a case in which the PUSCH transmission of the dual CWs is scheduled, when uplink control information (for example, UCI) is multiplexed/mapped to the PUSCH to be transmitted by the 8T×UE with rank >4, the UCI may be multiplexed/mapped to a specific CW from among the plurality of CWs scheduled. The specific CW may be determined based on the MCS index/a CW index. For example, the UCI may be multiplexed to the CW with a high MCS index, and in a case in which the MCS indices corresponding to the two CWs are the same, the UCI may be multiplexed to a first CW. In a case in which the PUSCH is retransmitted, an initial MCS may be applied to a CW selection.

Meanwhile, in the case in which the PUSCH transmission of the dual CWs with rank >4 is supported by the 8T×UE, a certain DCI field/indication may be applied commonly to the plurality thereof (for example, the two CWs).

For example, for the PUSCH transmission of the dual CWs with rank >4 by the 8T×UE, a physical layer priority indicator (for example, a PHY layer priority indicator) may be applied to the plurality of (for example, two) CWs.

For the PUSCH transmission of the dual CWs with rank >4 by the 8T×UE, a UL-SCH indicator (for example, a UL-SCH indicator) field included in the DCI to be used for scheduling the PUSCH (for example, DCI format 0_1/0_2) may be a single field. For the 8T×UE, the DCI to be used for scheduling the PUSCH (for example, DCI format 0_1/0_2) may indicate one UL-SCH indicator.

### UL-SCH Indicator

The UL-SCH indicator field may indicate whether the UL-SCH is transmitted with the PUSCH or not. For example, in a case in which the number of schedule PUSCHs to be indicated by a time domain resource assignment field (for example, a Time domain resource assignment field) is larger than one, the UL-SCH indicator field in the DCI may be configured to 0 bits and otherwise may be configured to a certain bit (for example, 1 bit).

In a case in which the UL-SCH indicator field in the DCI is configured to 1 bit, a first value (for example, “1”) may indicate that the UL-SCH is to be transmitted with the PUSCH, while a second value (for example, “0”) may indicate that the UL-SCH is not to be transmitted with the PUSCH. In a case in which the UE does not support a triggering of the SRS only by the DCI, except for a certain case, it does not need to be expected that the UL-SCH indicator is “0,” and all CSI request fields are 0 (in other words, the UE transmits UL data or an A-CSI report with the PUSCH). In a case in which the UE supports the triggering of the SRS only by the DCI, except for a certain case, it does not need to be expected that the UL-SCH indicator is “0,” all CSI request fields are 0, and all SRS request fields are 0 (in other words, the UE transmits the UL data, the A-CSI report or the A-SRS with the PUSCH). The certain case may be a case in which DCI format 0_1/0_2 is CRC-scrambled by an SP-CSI-RNTI.

In this way, in a case in which the UL-SCH indicator is “0,” it means that the UL-SCH is not to be transmitted by the PUSCH, and the UE does not need to expect to receive the DCI indicating that none of the UL-SCH, CSI or the SRS exist.

By the way, as described above, in the case in which the PUSCH transmission of the dual CWs is supported by the 8T×UE at a certain rank, it is also assumed that there may be a case in which there is one UL-SCH indicator to be indicated by scheduling DCI of the PUSCH. In this case, how to control the UL transmission control (for example, the UL-SCH corresponding to each CW) has not been sufficiently studied. For example, in a case in which the UL-SCH is indicated not to be transmitted with the PUSCH (for example, the UL-SCH indicator is to be “0”), how to control the CW to which the UL-SCH is applied is a problem.

The inventors of the present invention focused on a case in which the PUSCH transmission of the plurality of CWs is supported and came up with the idea of a method for appropriately performing the UL transmission in such a case. As an example, in the case in which the PUSCH transmission of the plurality of CWs is supported, the inventors studied the UL transmission control when the DCI indicates one transmission condition/parameter to come up with an example of the present embodiment.

The following description shows an example of the UL-SCH indicator (or the UL-SCH indicator field) as one transmission condition/parameter to be indicated by the DCI, but the present embodiment is not limited to this. It may be similarly applied to other indicators (or other fields) besides the UL-SCH indicator (or the UL-SCH indicator field).

Embodiments according to the present disclosure will be described in detail with reference to the drawings as follows. The radio communication methods according to respective embodiments may each be employed individually, or may be employed in combination.

In the present disclosure, “A/B” and “at least one of A and B” may be interchangeably interpreted. In the present disclosure, “A/B/C” may mean “at least one of A, B, and C.”

In the present disclosure, notify, activate, deactivate, indicate, select, configure, update, determine, and the like may be interchangeably interpreted. In the present disclosure, “support,” “control,” “controllable,” “operate,” “operable,” and the like may be interchangeably interpreted.

In the present disclosure, radio resource control (RRC), an RRC parameter, an RRC message, a higher layer parameter, a field, an information element (IE), a configuration, and the like may be interchangeably interpreted. In the present disclosure, a Medium Access Control control element (MAC Control Element (CE)), an update command, an activation/deactivation command, and the like may be interchangeably interpreted.

In the present disclosure, the higher layer signaling may be, for example, any one or combinations of Radio Resource Control (RRC) signaling, Medium Access Control (MAC) signaling, broadcast information, other messages (for example, a message from the core network, such as positioning protocol (for example, NR Positioning Protocol A (NRPPa)/LTE Positioning Protocol (LPP)) messages), and the like.

In the present disclosure, the MAC signaling may use, for example, a MAC control element (MAC CE), a MAC Protocol Data Unit (PDU), or the like. The broadcast information may be, for example, a master information block (MIB), a system information block (SIB), minimum system information (Remaining Minimum System Information (RMSI)), other system information (OSI), or the like.

In the present disclosure, the physical layer signaling may be, for example, downlink control information (DCI), uplink control information (UCI), or the like.

In the present disclosure, a TPMI and a TPMI index may be interchangeably interpreted. A port and an antenna port may be interchangeably interpreted. 8TX (8 transmissions) may mean 8 ports or 8 antenna ports. The port/antenna port may mean a port/antenna port for UL (for example, SRS/PUSCH) transmission.

In the present disclosure, an SRS resource set and a resource set may be interchangeably interpreted. A coherent group and an SRS resource set may be interchangeably interpreted.

Although the 8TX is mainly described in the present description, the present description may be applied to 5TX, 6TX, 7TX, TX equal to or greater than 8, TX equal to or less than 4, and the like in the same manner as in the 8TX. In the following embodiments, “8” may be interpreted as “n (n is any integer)”, and in this case, the number of layers/the number of ports, and the like described under assumption of the maximum value being “8” can be appropriately interpreted with assumption of the maximum value being “n” by those skilled in the art.

In the present disclosure, “having a capability of” and “supporting/reporting a capability of” may be interchangeably interpreted.

In the present disclosure, a rank, a transmission rank, the number of layers, and the number of antenna ports may be interchangeably interpreted. One codeword being applied and the number of layers being four or less may be interchangeably interpreted. Two codewords being applied and the number of layers being larger than four layers may be interchangeably interpreted.

### Radio Communication Method

### First Embodiment

The first embodiment relates to the UL transmission control in a case in which one certain DCI field (or transmission condition/parameter) is indicated for the UL transmission with a rank larger than a certain value or the UL transmission of the plurality of CWs (for example, the two CWs/dual CWs).

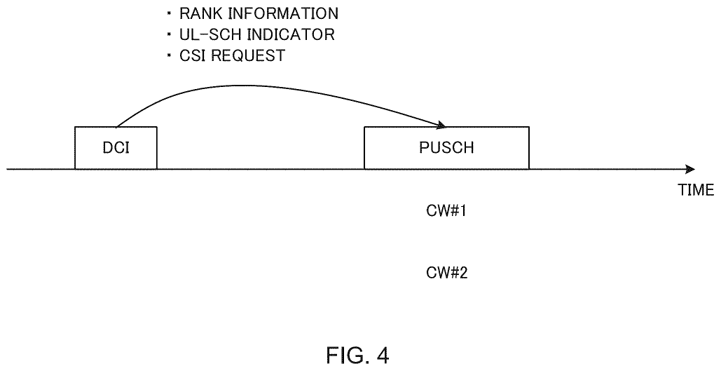

The UE may receive the DCI that schedules the PUSCH transmission using the rank larger than a certain value/the PUSCH transmission of the plurality of CWs (see FIG. 4). Scheduling may be read interchangeably with activation/triggering. The DCI may be a certain DCI format (for example, DCI format 0_1/0_2). The DCI to be used for scheduling the PUSCH may include at least one of information on the rank of the PUSCH (for example, rank information), the UL-SCH indicator and a CSI request.

The PUSCH transmission of the plurality of CWs (for example, CW #1 and CW #2) may be applied to the rank larger than a certain value. In the following description, rank may be replaced with layer. The certain value (for example, X) may be a specific value to be defined in specifications (for example, X=4 or another value), a value to be configured for the UE by the higher layer parameter or a value to be determined based on the report of the UE capability.

In the present disclosure, the information on the rank to be applied to the PUSCH (or the rank information) may be indicated to the UE by the DCI (for example, the DCI that schedules the PUSCH). The UE may perform the PUSCH transmission of a 1CW or the PUSCH transmission of the 2CWs based on the number of ranks indicated by the DCI. The rank information may be indicated to the UE by a TPMI field/the SRI field included in the DCI.

For the codebook-based PUSCH transmission, the UE may determine the number of ranks based on the TPMI field included in the DCI. For the non-codebook-based PUSCH transmission, the UE may determine the number of ranks based on the SRI field included in the DCI.

In a case in which the number of ranks indicated by the DCI is larger than a certain value, the UE may determine that the PUSCH transmission of the 2CWs is to be indicated. In this way, whether to perform the PUSCH transmission of the 1CW or the PUSCH transmission of the 2CWs may be implicitly/explicitly indicated to the UE by the DCI.

In a case in which the rank larger than a certain value is indicated (or the PUSCH transmission of the 2CWs is scheduled), and the PUSCH to which the uplink shared channel (UL-SCH) is transmitted is indicated (for example, the UL-SCH indicator included in the DCI is to be “1”), the UE may transmit the UL-SCH in the 2CWs.

In a case in which a rank larger than a certain value is indicated (or the PUSCH transmission of the 2CWs is scheduled), and the indication of the PUSCH to which the UL-SCH is not to be transmitted (for example, the UL-SCH indicator included in the DCI is “0”) is supported, the UE may apply at least one of the following options 1-1 through 1-3.

### Option 1-1

A possible value for the UL-SCH indicator included in such DCI may be restricted based on at least one of the rank for the PUSCH (or the number of CWs for the PUSCH) and the value of the CSI request field included in the DCI.

For example, in the case in which the rank is larger than a certain value (or in a case in which the PUSCH transmission of the 2CWs is applied), the PUSCH to which the UL-SCH is not to be transmitted (or the PUSCH to which the UL-SCH is not to be transmitted and the CSI is to be transmitted) may be restricted. The PUSCH to which the UL-SCH is not to be transmitted (or the PUSCH to which the UL-SCH is not to be transmitted and the CSI is to be transmitted) may be supported/allowed only for a rank of a certain value or smaller (or the PUSCH transmission of the 1CW).

For example, in a case in which the rank larger than a certain value (for example, rank >4) is indicated for the PUSCH, the UE does not need to expect that the UL-SCH indicator is to be “0” (for example, that the PUSCH to which the UL-SCH is not to be transmitted is indicated).

In a case in which the rank larger than a certain value is indicated for the PUSCH and the CSI request field is a non-zero value (for example, a non-zero value), the UE does not need to expect/assume that the UL-SCH indicator is to be “0” (for example, that the PUSCH to which the UL-SCH is not to be transmitted is indicated). In the present disclosure, the CSI request field having the non-zero value may mean that at least one CSI reporting/CSI feedback makes a request.

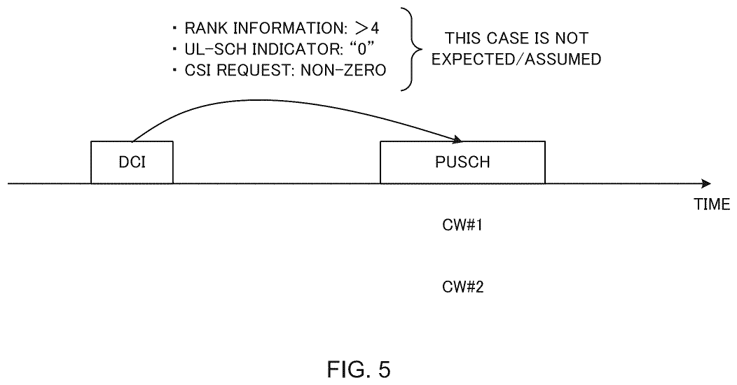

In other words, the UE does not need to expect/assume a case in which the rank larger than a certain value, UL-SCH=0 and the CSI request field=non-zero indicate/occur at the same time for the PUSCH (see FIG. 5).

In a case in which the UL-SCH indicator is indicated to be “0” (for example, the PUSCH to which the UL-SCH is not to be transmitted is indicated), the UE may expect/determine that the rank of a certain value or smaller (or the PUSCH transmission of the 1CW) is indicated/applied.

In a case in which the UL-SCH indicator is indicated to be “0” (for example, the PUSCH to which the UL-SCH is not to be transmitted is indicated) and the CSI request field is indicated to be a non-zero value (or a value other than zero), the UE may expect/determine that the rank of a certain value or smaller (or the PUSCH transmission of the 1CW) is indicated/applied. In this Case, a case in which the CSI is to be transmitted without the UL-SCH transmission for the PUSCH may mean that the rank to be indicated is supported/allowed only when it is smaller than four (or the PUSCH transmission of the 1CW).

In option 1-1, in the case in which the PUSCH transmission of the 2CWs is applied, the configuration can be such that the PUSCH transmission without the UL-SCH transmission (or the PUSCH transmission in which the CSI is to be transmitted without the UL-SCH transmission) is not performed. This enables the UL-SCH/a CSI transmission in each CW to be performed appropriately even in a case in which the UL-SCH indicator field is not provided separately for the plurality of CWs (or a common UL-SCH indicator field is applied).

### Option 1-2

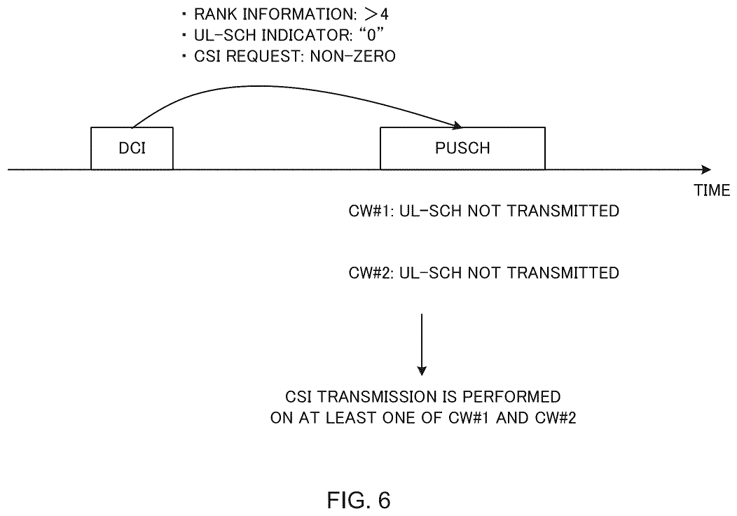

In a case in which the rank larger than a certain value is indicated by the DCI (or the PUSCH transmission of the 2CWs is applied), and the UL-SCH indicator is indicated to be “0” by such DCI (for example, the PUSCH to which the UL-SCH is not to be transmitted is indicated), the UL-SCH does not need to be transmitted in the two CWs (see FIG. 6). In a case in which the rank larger than a certain value and UL-SCH indication=0 are indicated by the DCI, the UE may determine that the UL-SCH to be transmitted in the two CWs does not exist.

In this case, the CSI request field may indicate a non-zero value (or a value other than zero). The CSI to be requested/triggered by the CSI request field may be transmitted in a specific CW. The specific CW may be determined based on at least one of the index corresponding to the CW and the MCS index corresponding to the CW. For example, the following options 1-2-1 through 1-2-5 may be applied to the transmission of the CSI to be requested/triggered by the CSI request field.

In the present disclosure, the transmission of the CSI may be read interchangeably with the CSI reporting or the CSI feedback. The CSI transmission in a certain CW may be read interchangeably with the CSI transmission for the PUSCH corresponding to the certain CW.

### Option 1-2-1

The CSI to be requested/triggered by the CSI request field of the DCI may be transmitted in the first CW (for example, the first CW). The UE may transmit the CSI without transmitting the UL-SCH in the first CW (or the PUSCH corresponding to the first CW).

### Option 1-2-2

The CSI to be requested/triggered by the CSI request field of the DCI may be transmitted in the second CW (for example, the second CW). The UE may transmit the CSI without transmitting the UL-SCH in the second CW (or the PUSCH corresponding to the second CW).

### Option 1-2-3

The CSI to be requested/triggered by the CSI request field of the DCI may be transmitted in the CW with a high MCS index (for example, the CW with higher MCS index). The UE may transmit the CSI without transmitting the UL-SCH in the CW with a high MCS index.

In the case in which the MCS indices corresponding to the two CWs are the same, the CSI may be transmitted in either the first CW or the second CW.

In the case in which the PUSCH (for example, the PUSCH of the 2CWs) is retransmitted, the CW in which the CSI is to be transmitted may be determined based on the MCS index to be applied to an initial transmission. Alternatively, in the case in which the PUSCH (for example, the PUSCH of the 2CWs) is retransmitted, the CW in which the CSI is to be transmitted may be determined based on the MCS index to be applied to a retransmission.

### Option 1-2-4

The CSI to be requested/triggered by the CSI request field of the DCI may be transmitted in the CW with a low MCS index (for example, the CW with lower MCS index). The UE may transmit the CSI without transmitting the UL-SCH in the CW with a low MCS index.

In the case in which the MCS indices corresponding to the two CWs are the same, the CSI may be transmitted in either the first CW or the second CW.

In the case in which the PUSCH (for example, the PUSCH of the 2CWs) is retransmitted, the CW in which the CSI is to be transmitted may be determined based on the MCS index to be applied to the initial transmission. Alternatively, in the case in which the PUSCH (for example, the PUSCH of the 2CWs) is retransmitted, the CW in which the CSI is to be transmitted may be determined based on the MCS index to be applied to the retransmission.

### Option 1-2-5

The CSI to be requested/triggered by the CSI request field of the DCI may be transmitted in both the first CW (for example, the first CW) and the second CW (for example, the second CW). The UE may transmit the CSI without transmitting the UL-SCH in both of the CWs.

In options 1-2-1 through 1-2-4, the indication not to perform the UL-SCH transmission is applied to the two CWs, and the CSI transmission is performed on one of the CWs. In option 1-2-5, the indication not to perform the UL-SCH transmission is applied to the two CWs, which corresponds to a case in which the CSI transmission is performed in both of the CWs.

In option 1-2, in the case in which the PUSCH transmission of the 2CWs is applied, the configuration in which the UL-SCH transmission is not performed to the two CWs is applied based on one UL-SCH indicator (for example, “0”). This enables the UL transmission to be performed appropriately even in a case in which the indication is performed for the 2CWs by one UL-SCH indicator. The transmission of the CSI using one of the 2CWs can suppress an increase in an overhead of the UL transmission.

Note that option 1-2 shows an example of the CSI transmission, but it is not limited to this. It may be similarly applied to an SRS transmission.

### Option 1-3

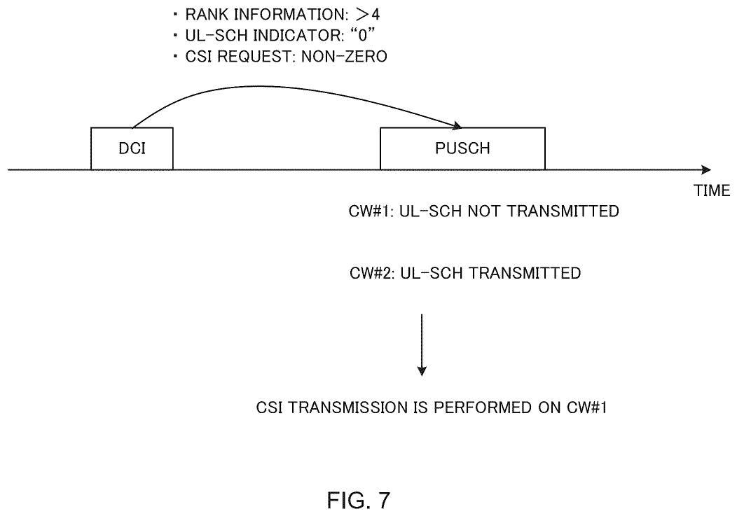

In the case in which the rank larger than a certain value is indicated by the DCI (or the PUSCH transmission of the 2CWs is applied), and the UL-SCH indicator is indicated to be “0” by such DCI (for example, the PUSCH to which the UL-SCH is not to be transmitted is indicated), the UL-SCH does not need to be transmitted in the one CW (for example, CW #A) (see FIG. 7). In this case, the transmission of the UL-SCH may be performed in another CW (for example, CW #B). FIG. 7 shows a case in which the UL-SCH is not transmitted in CW #1 (CW #1 corresponds to CW #A) and the UL-SCH is transmitted in CW #2 (CW #2 corresponds to CW #B), but it is not limited to this.

In the case in which the rank larger than a certain value and UL-SCH indication=0 are indicated by the DCI, the UE may determine that the UL-SCH does not exist for one CW, while the UL-SCH exists for another CW.

In this case, the CSI request field may indicate a non-zero value (or a value other than zero). The CSI to be requested/triggered by the CSI request field may be transmitted in a specific CW (for example, CW #A in which the UL-SCH is not to be transmitted). A specific CW #A may be determined based on at least one of the index corresponding to the CW, the MCS index corresponding to the CW, a TB size corresponding to the CW and a layer index (layer no.) corresponding to the CW. For example, the following options 1-3-1 through 1-3-7 may be applied to the transmission of the CSI to be requested/triggered by the CSI request field.

### Option 1-3-1

The CSI to be requested/triggered by the CSI request field of the DCI may be transmitted in the first CW (for example, the first CW). The UE may transmit the CSI without transmitting the UL-SCH in the first CW (or the PUSCH corresponding to the first CW). The UE may transmit the UL-SCH in another CW (or the PUSCH corresponding to another CW) without transmitting the CSI.

### Option 1-3-2

The CSI to be requested/triggered by the CSI request field of the DCI may be transmitted in the second CW (for example, the second CW). The UE may transmit the CSI without transmitting the UL-SCH in the second CW (or the PUSCH corresponding to the second CW). The UE may transmit the UL-SCH in another CW (or the PUSCH corresponding to another CW) without transmitting the CSI.

### Option 1-3-3

The CSI to be requested/triggered by the CSI request field of the DCI may be transmitted in the CW with a high MCS index (for example, the CW with higher MCS index). The UE may transmit the CSI without transmitting the UL-SCH in the CW with a high MCS index.

In the case in which the MCS indices corresponding to the two CWs are the same, the CSI may be transmitted in either the first CW or the second CW.

In the case in which the PUSCH (for example, the PUSCH of the 2CWs) is retransmitted, the CW in which the CSI is to be transmitted may be determined based on the MCS index to be applied to the initial transmission. Alternatively, in the case in which the PUSCH (for example, the PUSCH of the 2CWs) is retransmitted, the CW in which the CSI is to be transmitted may be determined based on the MCS index to be applied to the retransmission.

### Option 1-3-4

The CSI to be requested/triggered by the CSI request field of the DCI may be transmitted in the CW with a low MCS index (for example, the CW with lower MCS index). The UE may transmit the CSI without transmitting the UL-SCH in the CW with a low MCS index.

In the case in which the MCS indices corresponding to the two CWs are the same, the CSI may be transmitted in either the first CW or the second CW.

In the case in which the PUSCH (for example, the PUSCH of the 2CWs) is retransmitted, the CW in which the CSI is to be transmitted may be determined based on the MCS index to be applied to the initial transmission. Alternatively, in the case in which the PUSCH (for example, the PUSCH of the 2CWs) is retransmitted, the CW in which the CSI is to be transmitted may be determined based on the MCS index to be applied to the retransmission.

### Option 1-3-5

The CSI to be requested/triggered by the CSI request field of the DCI may be transmitted in the CW with a high TB size/high layer index (for example, the CW with higher TB size/#layers) . The UE may transmit the CSI without transmitting the UL-SCH in the CW with a high TB size/high layer index.

In a case in which the TB sizes/layer indices corresponding to the two CWs are the same, the CW in which the CSI is to be transmitted may be determined based on the CW index/MCS index.

In the case in which the PUSCH (for example, the PUSCH of the 2CWs) is retransmitted, the CW in which the CSI is to be transmitted may be determined based on the TB size/layer index to be applied to the initial transmission. Alternatively, in the case in which the PUSCH (for example, the PUSCH of the 2CWs) is retransmitted, the CW in which the CSI is to be transmitted may be determined based on the TB size/layer index to be applied to the retransmission.

### Option 1-3-6

The CSI to be requested/triggered by the CSI request field of the DCI may be transmitted in the CW with a low TB size/low layer index (for example, the CW with lower TB size/#layers). The UE may transmit the CSI without transmitting the UL-SCH in the CW with a low TB size/low layer index.

In the case in which the TB sizes/layer indices corresponding to the two CWs are the same, the CW in which the CSI is to be transmitted may be determined based on the CW index/MCS index.

In the case in which the PUSCH (for example, the PUSCH of the 2CWs) is retransmitted, the CW in which the CSI is to be transmitted may be determined based on the TB size/layer index to be applied to the initial transmission. Alternatively, in the case in which the PUSCH (for example, the PUSCH of the 2CWs) is retransmitted, the CW in which the CSI is to be transmitted may be determined based on the TB size/layer index to be applied to the retransmission.

### Option 1-3-7

The CSI to be requested/triggered by the CSI request field of the DCI may be transmitted in both the first CW (for example, the first CW) and the second CW (for example, the second CW). The UE may transmit the CSI without transmitting the UL-SCH in one CW while transmitting the UL-SCH and the CSI in the other CW.

Option 1-3 shows an example of the CSI transmission, but it is not limited to this. It may be similarly applied to the SRS transmission.

In each of the options shown in the first embodiment, the UE capability may be introduced. For example, the UE capability with respect to the transmission of only the CSI for the PUSCH with the rank larger than a certain value (for example, rank >4) (for example, the PUSCH transmission that performs the CSI transmission without the UL-SCH transmission) may be introduced. The rank corresponding to the PUSCH may be configured/indicated to the UE from the base station with the RRC/DCI.

### Second Embodiment

The second embodiment relates to the UL transmission control when the rank of a certain value or smaller is indicated by the DCI (or when only a 1CW transmission is scheduled/when the 1CW is indicated as disabled) in a case in which the UL transmission with the maximum rank larger than a certain rank (for example, the PUSCH transmission) is supported. The second embodiment (for example, each of the options shown in the second embodiment) may be applied in combination with the first embodiment (for example, each of the options shown in the first embodiment) as appropriate.

The UE may receive information on the higher layer parameter with respect to the maximum rank (for example, a max rank). The UE may be configured with the maximum rank of a certain value or larger (for example, rank >4) by the RRC. The UE may receive information on the number of ranks to be applied to the PUSCH transmission by the DCI.

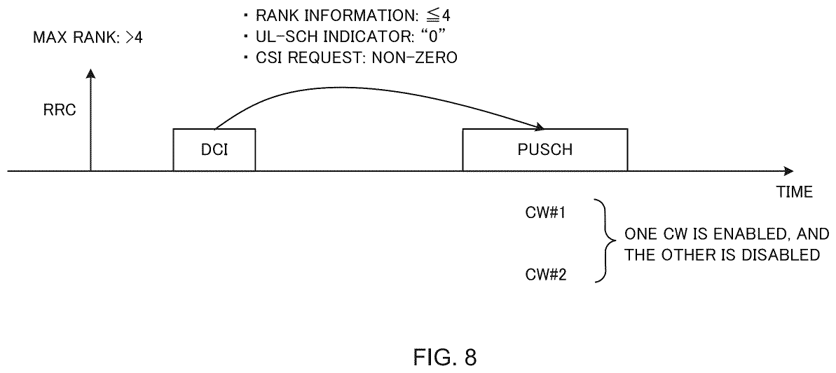

For example, even in a case in which the maximum rank of a certain value or larger is configured, the DCI that schedules the PUSCH may indicate the rank of a certain value or smaller (for example, rank ≤4) (see FIG. 8). The rank of a certain value or smaller (for example, rank ≤4) being indicated may mean that one CW of the 2CWs is to be indicated as disabled, that one CW of the 2CWs is to be indicated as enabled, or that the PUSCH with only one CW is to be scheduled. The CW to be enabled/disabled may be determined based on a certain condition (for example, the CW index) or may be indicated to the UE from the base station.

In this case, the PUSCH transmission to which the UL-SCH is not to be transmitted being indicated by the UL-SCH indicator included in the DCI (for example, UL-SCH indicator=0) may be supported. The CSI request field of such DCI may indicate a non-zero value (or a value other than zero).

In a case in which the maximum rank of a certain value or larger is configured, and the DCI indicates a rank of a certain value or smaller, UL-SCH indicator=0 and the CSI request field of a non-zero value, the UE may apply at least one of the following options 2-1 through 2-2.

### Option 2-1

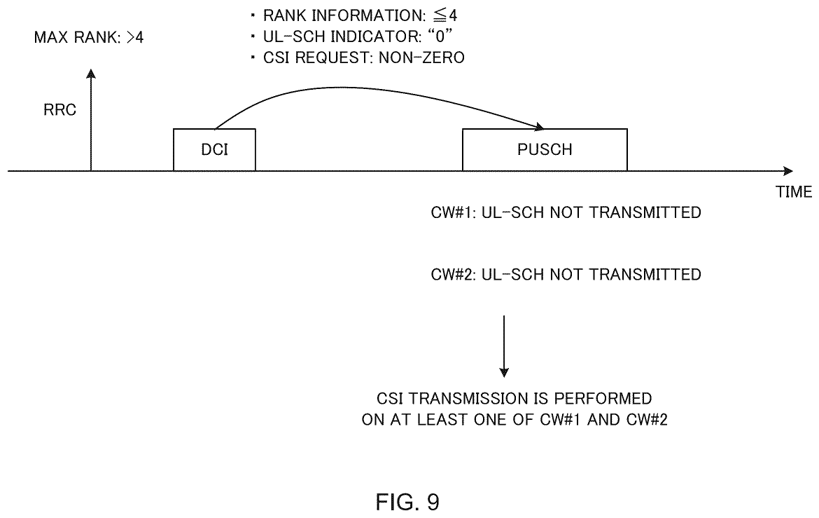

In a case in which the maximum rank of a certain value or larger is configured, and the DCI indicates a rank of a certain value or smaller and UL-SCH indicator=0, the configuration may be such that the UL-SCH is not to be transmitted in any CW or that the UL-SCH does not exist in any CW (see FIG. 9). For example, in the case in which the maximum rank of a certain value or larger (for example, rank >4) is configured, and the DCI indicates a rank of a certain value or smaller (for example, rank ≤4), UL-SCH indicator=0 and the CSI request field of a non-zero value, the UE may determine that the UL-SCH does not exist for the two CWs.

In a case in which the DCI indicates the CSI request field of a non-zero value, the CSI to be requested/triggered by such a CSI request field may be transmitted in a specific CW. The specific CW may be determined based on at least one of the index corresponding to the CW and the MCS index corresponding to the CW. For example, the following options 2-1-1 through 2-1-6 may be applied to the transmission of the CSI to be requested/triggered by the CSI request field.

### Option 2-1-1

The CSI to be requested/triggered by the CSI request field of the DCI may be transmitted in the first CW (for example, the first CW). The UE may transmit the CSI without transmitting the UL-SCH in the first CW (or the PUSCH corresponding to the first CW).

### Option 2-1-2

The CSI to be requested/triggered by the CSI request field of the DCI may be transmitted in the second CW (for example, the second CW). The UE may transmit the CSI without transmitting the UL-SCH in the second CW (or the PUSCH corresponding to the second CW).

### Option 2-1-3

The CSI to be requested/triggered by the CSI request field of the DCI may be transmitted in the CW indicated as enabled (for example, a CW indicated as enabled). The UE may transmit the CSI without transmitting the UL-SCH in the CW indicated as enabled for the PUSCH corresponding to the CW indicated as enabled).

### Option 2-1-4

The CSI to be requested/triggered by the CSI request field of the DCI may be transmitted in the CW indicated as disabled (for example, a CW indicated as disabled CW). The UE may transmit the CSI without transmitting the UL-SCH in the CW indicated as disabled (or the PUSCH corresponding to the CW indicated as disabled).

### Option 2-1-5

The CSI to be requested/triggered by the CSI request field of the DCI may be transmitted in the CW with a high MCS index (for example, the CW with higher MCS index). The UE may transmit the CSI without transmitting the UL-SCH in the CW with a high MCS index.

In the case in which the MCS indices corresponding to the two CWs are the same, the UE may determine the CW in which the CSI is transmitted based on at least one of the CW index and enablement/disablement of the CW (enabled/disabled).

In the case in which the PUSCH (for example, the PUSCH of the 2CWs) is retransmitted, the CW in which the CSI is to be transmitted may be determined based on the MCS index to be applied to the initial transmission. Alternatively, in the case in which the PUSCH (for example, the PUSCH of the 2CWs) is retransmitted, the CW in which the CSI is to be transmitted may be determined based on the MCS index to be applied to the retransmission.

### Option 2-1-6

The CSI to be requested/triggered by the CSI request field of the DCI may be transmitted in the CW with a low MCS index (for example, the CW with lower MCS index). The UE may transmit the CSI without transmitting the UL-SCH in the CW with a low MCS index.

In the case in which the MCS indices corresponding to the two CWs are the same, the UE may determine the CW in which the CSI is transmitted based on at least one of the CW index and the enablement/disablement of the CW (enabled/disabled).

In the case in which the PUSCH (for example, the PUSCH of the 2CWs) is retransmitted, the CW in which the CSI is to be transmitted may be determined based on the MCS index to be applied to the initial transmission. Alternatively, in the case in which the PUSCH (for example, the PUSCH of the 2CWs) is retransmitted, the CW in which the CSI is to be transmitted may be determined based on the MCS index to be applied to the retransmission.

In option 2-1, even when the maximum rank is larger than a certain value, in the case in which the rank indicated by the DCI is a certain value or smaller (in a case in which only one of the two CWs is enabled or disabled), whether the UL-SCH is transmitted by the UL-SCH indicator or not is applied commonly to the two CWs. In a case in which the CSI request requests the CSI feedback (for example, in a case in which the CSI request field is non-zero), the transmission of the CSI is performed using a specific CW (for example, the one CW). In this way, the transmission of the CSI using one of the 2CWs can suppress an increase in the overhead of the UL transmission.

### Option 2-2

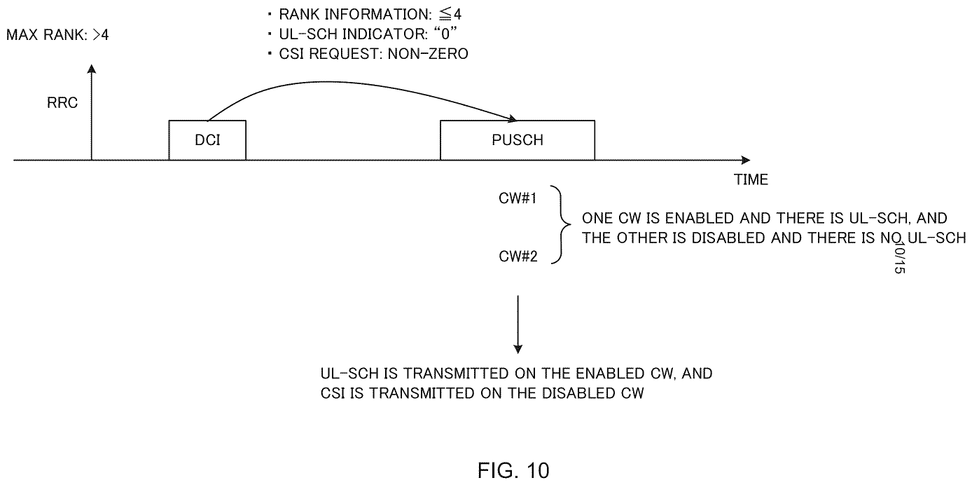

In a case in which the maximum rank of a certain value or larger is configured, and the DCI indicates a rank of a certain value or smaller and UL-SCH indicator=0, the UL-SCH may be transmitted in a specific CW (for example, the one CW). The specific CW may be the CW to be enabled (an enabled CW). For example, in the case in which the maximum rank of a certain value or larger (for example, rank >4) is configured, and the DCI indicates a rank of a certain value or smaller (for example, rank ≤4), UL-SCH indicator=0 and the CSI request field of a non-zero value, the UE may determine that the UL-SCH for one CW exists and the UL-SCH for the other CW does not exist (see FIG. 10).

In the case in which the DCI indicates the CSI request field of a non-zero value, the CSI to be requested/triggered by such a CSI request field may be transmitted in the CW in which the UL-SCH is not to be transmitted (for example, the CW to be disabled (a disabled CW)).

In a case in which UL-SCH indicator=1 is indicated, the CSI to be requested/triggered by the CSI request field may be transmitted in the CW in which the UL-SCH is to be transmitted (for example, the CW to be enabled (the enabled CW)). In other words, the CW in which the CSI is to be transmitted/multiplexed (the CW to be enabled/the CW to be disabled) may be changed based on the value of the UL-SCH indicator.

In each of the options shown in the second embodiment, the UE capability may be introduced. For example, the UE capability with respect to the transmission of only the CSI for the PUSCH with the rank of a certain value or smaller (for example, rank ≤4) (for example, the PUSCH transmission that performs the CSI transmission without the UL-SCH transmission) may be introduced. The maximum rank corresponding to the PUSCH (for example, rank >4) may be configured for the UE from the base station by the RRC, and the rank of the PUSCH transmission may be indicated to the UE from the base station by the DCI.

### Variation 1

Cases in which DCI format 0_1/DCI format 0_2 is applied as the scheduling/rank indication/indication of the UL-SCH indicator/indication of the CSI request of the PUSCH are shown in the first embodiment/second embodiment, but applicable DCI formats are not limited to these. The DCI applicable to the scheduling/rank indication/indication of the UL-SCH indicator/indication of the CSI request of the PUSCH may be limited only to a specific DCI format (for example, DCI format 0_1).

### Variation 2

Examples of the UL-SCH indicator (or the UL-SCH indicator field) as one transmission condition/parameter to be indicated by the DCI in cases in which the PUSCH transmission of the plurality of CWs is supported are described in the first embodiment/second embodiment, but the present embodiments are not limited to these. They may be similarly applied to other DCI fields besides the UL-SCH indicator (or the UL-SCH indicator field) (for example, other DCI fields that are configured with only one for other plurality of CWs).

For example, in a case in which the rank larger than a certain value is indicated (or in a case in which the PUSCH transmission of the plurality of CWs is scheduled), indication contents of such other DCI fields may be applied to the two CWs. Alternatively, in the case in which the rank larger than a certain value is indicated (or in the case in which the PUSCH transmission of the plurality of CWs is scheduled), the indication contents of such other DCI fields may be applied to one CW of the two CWs. Any of the methods shown in the first embodiment/second embodiment described above (for example, a method for selecting the CW in which the CSI is transmitted) may be applied as a selection method of the CW to which such other DCI fields are applied.

### SUPPLEMENTS

### Notification of Information to UE

Notification of any information to a UE (from a network (NW) (for example, a base station (BS))) (in other words, reception of any information from the BS in the UE) in the above-described embodiments may be performed by using physical layer signaling (for example, DCI), higher layer signaling (for example, RRC signaling, MAC CE), a specific signal/channel (for example, a PDCCH, a PDSCH, a reference signal), or a combination of these.

When the notification is performed by a MAC CE, the MAC CE may be identified by a new logical channel ID (LCID) not defined in an existing standard being included in a MAC subheader.

When the notification is performed by DCI, the notification may be performed by a specific field of the DCI, a radio network temporary identifier (RNTI) used for scrambling of cyclic redundancy check (CRC) bits given to the DCI, a format of the DCI, or the like.

Notification of any information to a UE in the above-described embodiments may be performed periodically, semi-persistently, or aperiodically.

### Notification of Information From UE

Notification of any information from a UE (to an NW) (in other words, transmission/reporting of any information to the BS from the UE) in the above-described embodiments may be performed by using physical layer signaling (for example, UCI), higher layer signaling (for example, RRC signaling, MAC CE), a specific signal/channel (for example, a PUCCH, a PUSCH, a PRACH, a reference signal), or a combination of these.

When the notification is performed by a MAC CE, the MAC CE may be identified by a new LCID not defined in existing standards being included in a MAC subheader.

When the notification is performed by UCI, the notification may be transmitted by using a PUCCH or a PUSCH.

Notification of any information from a UE in the above-described embodiments may be performed periodically, semi-persistently, or aperiodically.

### Regarding Application of Each Embodiment

At least one of the above-described embodiments may be applied to a case satisfying a specific condition. The specific condition may be defined in a standard, or a UE/BS may be notified of the specific condition by using higher layer signaling/physical layer signaling.

At least one of the above-described embodiments may be applied only to a UE that has reported a specific UE capability or that supports the specific UE capability.

The specific UE capability may indicate at least one of the following:
supporting a specific processing/operation/control/information (for example, a UL-SCH identifier=0 for a rank larger than a certain value/CSI request field being a non-zero value, or the like) for at least one of the above-described embodiments,
supporting a PUSCH transmission without UL-SCH transmission (or with only CSI transmission) in a rank larger than a certain value (for example, rank >4), and
supporting a PUSCH transmission without UL-SCH transmission (or with only CSI transmission) in a case that a maximum rank larger than a certain value (for example, maximum rank >4) and a rank equal to or less than a certain value (for example, rank ≤4) are configured/indicated.

The specific UE capability may be capability applied over all the frequencies (commonly irrespective of frequency), capability per frequency (for example, one or a combination of cell, band, band combination, BWP, component carrier, and the like), capability per frequency range (for example, Frequency Range 1 (FR1), FR2, FR3, FR4, FR5, FR2-1, FR2-2), capability per subcarrier spacing (SCS), or capability per Feature Set (FS) or Feature Set Per Component-carrier (FSPC).

The specific UE capability may be capability applied over all the duplex schemes (commonly irrespective of duplex scheme) or capability per duplex scheme (for example, time division duplex (TDD) or frequency division duplex (FDD)).

At least one of the above-described embodiments may be applied when the UE is configured/activated/triggered with specific information related to the above-described embodiment (or performance of the operation of the above-described embodiment) by higher layer signaling/physical layer signaling. For example, the specific information may be information indicating enabling of certain operation, any RRC parameter for a specific release (for example, Rel. 18/19), or the like.

When the UE does not support at least one of the specific UE capabilities above or is not configured with the specific information, operation of Rel. 15/16 may be applied, for example.

### SUPPLEMENTARY NOTE

Regarding one embodiment of the present disclosure, the following supplementary notes of the invention will be given.

### Supplementary Note 1

A terminal including: a receiving section that receives downlink control information to be used for scheduling a physical uplink shared channel (PUSCH); and a control section that controls, based on information on a rank of the PUSCH and information on whether an uplink shared channel (UL-SCH) is transmitted or not included in the downlink control information, a transmission of the UL-SCH and channel state information in one or more codewords (CWs) corresponding to the PUSCH.

### Supplementary Note 2

The terminal according to supplementary note 1, wherein in a case in which the information on the rank of the PUSCH indicates a rank larger than a certain value, and the information on whether the UL-SCH is to be transmitted or not indicates that the UL-SCH is not to be transmitted, the control section performs control such that the UL-SCH is not to be transmitted in at least one CW, and the channel state information is to be transmitted in the CW in which the UL-SCH is not to be transmitted.

### Supplementary Note 3

The terminal according to supplementary note 1 or 2, wherein in a case in which the information on the rank of the PUSCH indicates a rank larger than a certain value, and the information on whether the UL-SCH is to be transmitted or not indicates that the UL-SCH is not to be transmitted, the control section determines, based on at least one of an index of the CW, an index of a modulation/coding scheme (MCS), a transport block size, and a layer index, the CW in which the channel state information is transmitted.

### Supplementary Note 4

The terminal according to any one of supplementary notes 1 to 3, wherein in a case in which a value larger than a certain value is configured as a maximum rank of the PUSCH, the information on the rank of the PUSCH indicates a rank of the certain value or smaller, and the information on whether the UL-SCH is to be transmitted or not indicates that the UL-SCH is not to be transmitted, the control section performs control such that the UL-SCH is not to be transmitted in at least one CW, and the channel state information is to be transmitted in the CW in which the UL-SCH is not to be transmitted.

### Radio Communication System

Hereinafter, a structure of a radio communication system according to one embodiment of the present disclosure will be described. In this radio communication system, the radio communication method according to each embodiment of the present disclosure described above may be used alone or may be used in combination for communication.

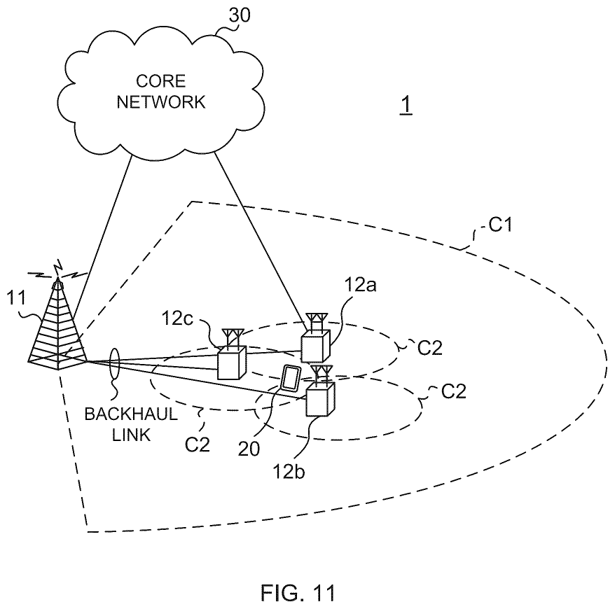

FIG. 11 is a diagram to show an example of a schematic structure of the radio communication system according to one embodiment. The radio communication system 1 (which may be simply referred to as system 1) may be a system implementing a communication using Long Term Evolution (LTE), 5th generation mobile communication system New Radio (5G NR) and so on the specifications of which have been drafted by Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (qNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (qNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FR1 may be a frequency band of 6 GHZ or less (sub-6 GHZ), and FR2 may be a frequency band which is higher than 24 GHZ (above −24 GHz). Note that frequency bands, definitions and so on of FR1 and FR2 are by no means limited to these, and for example, FR1 may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (5GCN), Next Generation Core (NGC), and so on.

The core network 30 may include network functions (NF), such as a User Plane Function (UPF), an Access and Mobility management Function (AMF), a Session Management Function (SMF), Unified Data Management (UDM), an Application Function (AF), a Data Network (DN), a Location Management Function (LMF), and operation, administration, and maintenance (Management) (OAM). Note that a plurality of functions may be provided by one network node. Communication with an external network (for example, the Internet) may be performed via the DN.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-s-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data”, and the PUSCH may be interpreted as “UL data”.

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a certain search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” on. Note that an SS, an SSB, and so on may be referred to as a “reference signal.”

In the radio communication system 1, a sounding reference signal (SRS), a demodulation reference signal (DMRS), and so on may be communicated as an uplink reference signal (UL-RS). Note that DMRS may be referred to as a “user terminal specific reference signal (UE-specific Reference Signal).”

### Base Station

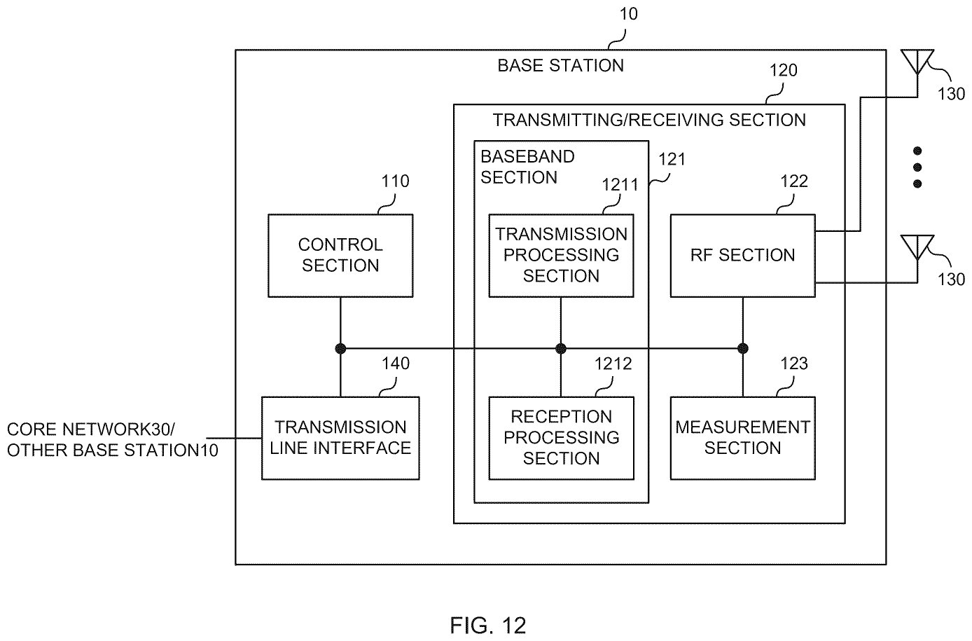

FIG. 12 is a diagram to show an example of a structure of the base station according to one embodiment. The base station 10 includes a control section 110, a transmitting/receiving section 120, transmitting/receiving antennas 130 and a communication path interface (transmission line interface) 140. Note that the base station 10 may include one or more control sections 110, one or more transmitting/receiving sections 120, one or more transmitting/receiving antennas 130, and one or more communication path interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping) , and so on. The control section 110 may control transmission and reception, measurement and so on using the transmitting/receiving section 120, the transmitting/receiving antennas 130, and the communication path interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DET) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and So on. The measurement results may be output to the control section 110.

The communication path interface 140 may perform transmission/reception (backhaul signaling) of a signal with an apparatus included in the core network 30 (for example, a network node providing NF) or other base stations 10, and so on, and acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the communication path interface 140.

The transmitting/receiving section 120 may transmit downlink control information to be used for scheduling a physical uplink shared channel (PUSCH).

The control section 110 may indicate, based on information on a rank of the PUSCH and information on whether an uplink shared channel (UL-SCH) is transmitted or not included in the downlink control information, a transmission of the UL-SCH and channel state information in one or more codewords (CWs) corresponding to the PUSCH.

### User Terminal

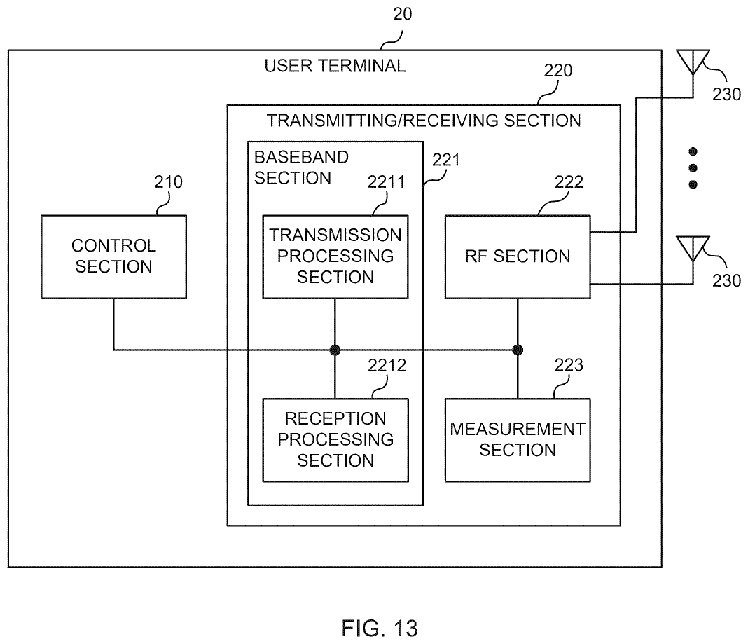

FIG. 13 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DET processing or not may be based on the configuration of the transform precoding. The transmitting/receiving section 220 (transmission processing section 2211) may perform, for a certain channel (for example, PUSCH), the DFT processing as the above-described transmission processing to transmit the channel by using a DFT-s-OFDM waveform if transform precoding is enabled, and otherwise, does not need to perform the DFT processing as the above-described transmission processing.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply reception processing such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the measurement section 223 may derive channel measurement for CSI calculation, based on a resource for channel measurement. The resource for channel measurement may be, for example, a non zero power (NZP) CSI-RS resource. The measurement section 223 may derive interference measurement for CSI calculation, based on a resource for interference measurement. The resource for interference measurement may be at least one of an NZP CSI-RS resource for interference measurement, a CSI-interference measurement (IM) resource, and the like. Note that CSI-IM may be referred to as CSI-interference management (IM), and may be interchangeably interpreted as zero power (ZP) CSI-RS. Note that, in the present disclosure, the CSI-RS, the NZP CSI-RS, the ZP CSI-RS, the CSI-IM, a CSI-SSB, and the like may be interchangeably interpreted.

Note that the transmitting section and the receiving section of the user terminal 20 in the present disclosure may be constituted with at least one of the transmitting/receiving section 220 and the transmitting/receiving antennas 230.

The transmitting/receiving section 220 may receive downlink control information to be used for scheduling a physical uplink Shared channel (PUSCH).

The control section 210 may control, based on information on a rank of the PUSCH and information on whether an uplink shared channel (UL-SCH) is transmitted or not included in the downlink control information, a transmission of the UL-SCH and channel state information in one or more codewords (CWs) corresponding to the PUSCH.

In a case in which the information on the rank of the PUSCH indicates a rank larger than a certain value, and the information on whether the UL-SCH is to be transmitted or not indicates that the UL-SCH is not to be transmitted, the control section 210 may perform control such that the UL-SCH is not to be transmitted in at least one CW, and the channel state information is to be transmitted in the CW in which the UL-SCH is not to be transmitted.

In a case in which the information on the rank of the PUSCH indicates a rank larger than a certain value, and the information on whether the UL-SCH is to be transmitted or not indicates that the UL-SCH is not to be transmitted, the control section 210 may determine, based on at least one of an index of the CW, an index of a modulation/coding scheme (MCS), a transport block size, and a layer index, the CW in which the channel state information is transmitted.

In a case in which a value larger than a certain value is configured as a maximum rank of the PUSCH, the information on the rank of the PUSCH indicates a rank of the certain value or smaller, and the information on whether the UL-SCH is to be transmitted or not indicates that the UL-SCH is not to be transmitted, the control section 210 may perform control such that the UL-SCH is not to be transmitted in at least one CW, and the channel state information is to be transmitted in the CW in which the UL-SCH is not to be transmitted.

### Hardware Structure

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate apparatuses (for example, via wire, wireless, or the like) and using these apparatuses. The functional blocks may be implemented by combining software into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but functions are by no means limited to these. For example, a functional block (component) to implement a function of transmission may be referred to as a “transmitting section (transmitting unit)”, a “transmitter”, or the like. The method for implementing each component is not particularly limited as described above.

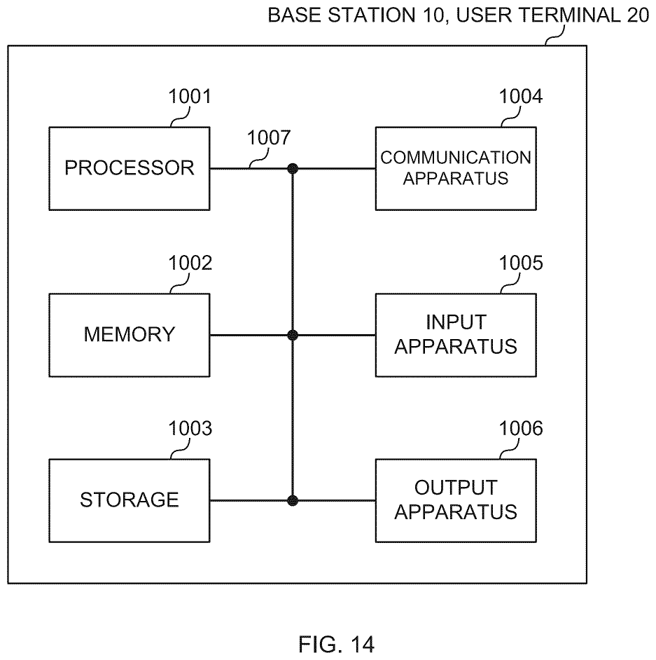

For example, a base station, a user terminal, and so on according to one embodiment of the present disclosure may function as a computer that executes the processes of the radio communication method of the present disclosure. FIG. 14 is a diagram to show an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably used. The hardware structure of the base station 10 and the user terminal 20 may be configured to include one or more of apparatuses shown in the drawings, or may be configured not to include part of apparatuses.

For example, although one processor 1001 is shown in the drawings, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminal 20 is implemented, for example, by allowing certain software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least a part of the control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least a part of the operations explained in the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register”, a “cache”, a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “auxiliary storage apparatus”.

The communication apparatus 1004 is hardware (transmitting/receiving device) for allowing inter-computer communication via at least one of wired and wireless networks, and may be referred to as, for example, a “network device”, a “network controller”, a “network card”, a “communication module”, and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the transmitting/receiving section 120 (220), the transmitting/receiving antenna 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor or the like). The output apparatus 1006 is an output device that allows sending output to the outside (for example, a display, a speaker, a Light Emitting Diode (LED) lamp or the like). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between apparatuses.

Also, the base station 10 and the user terminal 20 may be structured to include hardware such as a microprocessor, a Digital Signal Processor (DSP), an Application Specific Integrated Circuit (ASIC), a Programmable Logic Device (PLD), a Field Programmable Gate Array (FPGA), and so on, and a part or all of the functional blocks may be implemented by the hardware. For example, the processor 1001 may be implemented with at least one of these pieces of hardware.

### Variations

It should be noted that a term used in the present disclosure and a term required for understanding of the present disclosure may be replaced by a term having the same or similar meaning. For example, a channel, a symbol, and a signal (or signaling) may be interchangeably used. Further, a signal may be a message. A reference signal may be abbreviated as an RS, and may be referred to as a pilot, a pilot signal or the like, depending on which standard applies. Furthermore, a component carrier (CC) may be referred to as a cell, a frequency carrier, a carrier frequency and so on.

A radio frame may be constituted of one or a plurality of periods (frames) in the time domain. Each of one or a plurality of periods (frames) constituting a radio frame may be referred to as a “subframe”. Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a specific filter processing performed by a transceiver in the frequency domain, a specific windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot”, A mini-slot may be constituted of symbols in number less than the slot. A PDSCH (or PUSCH) transmitted in a time unit larger than a mini-slot may be referred to as “PDSCH (PUSCH) mapping type A”. A PDSCH (or PUSCH) transmitted using a mini-slot may be referred to as “PDSCH (PUSCH) mapping type B”.

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably used.

For example, one subframe may be referred to as a “TTI”, a plurality of consecutive subframes may be referred to as a “TTI”, or one slot or one mini-slot may be referred to as a “TTI”. In other words, at least one of a subframe and a TTI may be a subframe (1 ms) in existing LTE, may be a period shorter than 1 ms (for example, 1 to 13 symbols), or may be a period longer than 1 ms. Note that a unit expressing TTI may be referred to as a “slot”, a “mini-slot”, or the like, instead of a “subframe”.

Here, a TTI refers to the minimum time unit of scheduling in radio communication, for example. For example, in LTE systems, a base station performs, for user terminals, scheduling of allocating of radio resources (such as a frequency bandwidth and transmit power that are available for each user terminal) in TTI units. Note that the definition of TTIs is not limited to this.

The TTI may be a transmission time unit for channel-encoded data packets (transport blocks), code blocks, codewords, or the like, or may be a unit of processing in scheduling, link adaptation, or the like. Note that, when a TTI is given, a time interval (for example, the number of symbols) to which transport blocks, code blocks, codewords, or the like are actually mapped may be shorter than the TTI.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI”, a “normal subframe”, a “long subframe”, a “slot” and so on. A TTI that is shorter than a normal TTI may be referred to as a “shortened TTI”, a “short TTI”, a “partial or fractional TTI”, a “shortened subframe”, a “short subframe”, a “mini-slot”, a “sub-slot”, a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an Rb May Include One or a Plurality of Symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB))”, a “sub-carrier group (SCG)”, a “resource element group (REG)”, a “PRB pair”, an “RB pair” and so on.

Furthermore, a resource block may be constituted of one or a plurality of resource elements (REs). For example, one RE may correspond to a radio resource field of one subcarrier and one symbol.

A Bandwidth Part (BWP) (which may be referred to as a “fractional bandwidth”, and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for UL) and a DL BWP (BWP for DL). One or a plurality of BWPs may be configured in one carrier for a UE.

At least one of configured BWPs may be active, and a UE may not need to assume to transmit/receive a certain signal/channel outside the active BWP(s). Note that a “cell”, a “carrier”, and so on in the present disclosure may be used interchangeably with a “BWP”.

Note that the above-described structures of radio frames, subframes, slots, mini-slots, symbols, and so on are merely examples. For example, structures such as a the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Further, the information, parameters, and so on described in the present disclosure may be expressed using absolute values or relative values with respect to certain values, or may be expressed using another corresponding information. For example, a radio resource may be specified by a certain index.

The names used for parameters and so on in the present disclosure are in no respect used as limitations. Furthermore, mathematical expressions that use these parameters, and so on may be different from those explicitly disclosed in the present disclosure. Since various channels (PUCCH, PDCCH, and so on) and information elements may be identified by any suitable names, the various names allocated to these various channels and information elements are in no respect used as limitations.

The information, signals, and so on described in the present disclosure may be represented by using any of a variety of different technologies. For example, data, an instruction, a command, information, a signal, a bit, a symbol, a chip, and so on, described throughout the description of the present application, may be represented by a voltage, an electric current, electromagnetic waves, magnetic fields, a magnetic particle, optical fields, a photon, or any combination thereof.

Also, information, signals, and so on can be output at least one of from a higher layer to a lower layer and from a lower layer to a higher layer. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or added. The information, signals, and so on that has been output may be deleted. The information, signals, and so on that has been input may be transmitted to another apparatus.

Notification of information is by no means limited to the aspects/embodiments described in the present disclosure, and other methods may be used as well. For example, notification of information in the present disclosure may be implemented by using physical layer signaling (for example, downlink control information (DCI), uplink control information (UCI)), higher layer signaling (for example, Radio Resource Control (RRC) signaling, broadcast information (master information block (MIB), system information block (SIB), and so on), Medium Access Control (MAC) signaling and so on), and other signals or combinations of these.

Note that physical layer signaling may be referred to as “Layer 1/Layer 2 (L1/L2) control information (L1/L2 control signals)”, “L1 control information (L1 control signal)”, and so on. Also, RRC signaling may be referred to as an “RRC message”, and can be, for example, an RRC connection setup message, an RRC connection reconfiguration message, and so on. Also, MAC signaling may be notified using, for example, MAC control elements (MAC CES).

Also, notification of certain information (for example, notification of “X”) does not necessarily have to be performed explicitly, and can be performed implicitly (by, for example, not reporting this certain information or reporting another piece of information).

A decision may be realized by a value (0 or 1) represented by one bit, by a boolean value (true or false), or by comparison of numerical values (e.g., comparison with a certain value).

Software, irrespective of whether referred to as “software”, “firmware”, “middleware”, “microcode”, or “hardware description language”, or called by other terms, should be interpreted broadly to mean instructions, instruction sets, codes, code segments, program codes, programs, subprograms, software modules, applications, software applications, software packages, routines, subroutines, objects, executable files, execution threads, procedures, functions, and the like.

Also, software, instructions, information, and the like may be transmitted and received via a transmission medium. For example, when software is transmitted from a website, a server, or other remote sources by using at least one of wired technologies (coaxial cable, fiber optic cable, twisted-pair cable, digital subscriber line (DSL), and so on) and wireless technologies (infrared radiation, microwaves, and so on), at least one of these wired technologies and wireless technologies is also included in the definition of the transmission medium.

The terms “system” and “network” used in the present disclosure may be used interchangeably. The “network” may mean an apparatus (for example, a base station) included in the network.

In the present disclosure, the terms such as “precoding”, a “precoder”, a “weight (precoding weight)”, “quasi-co-location (QCL)”, a “Transmission Configuration Indication state (TCI state)”, a “spatial relation”, a “spatial domain filter”, a “transmit power”, “phase rotation”, an “antenna port”, a “layer”, “the number of layers”, a “rank”, a “resource”, a “resource set”, a “beam”, a “beam width”, a “beam angular degree”, an “antenna”, an “antenna element”, a “panel”, a “UE panel”, a “transmission entity”, a “reception entity”, and so on may be used interchangeably.

Note that, in the present disclosure, the “antenna port” may be used interchangeably with an “antenna port for an arbitrary signal/channel” (for example, a demodulation reference signal (DMRS) port). In the present disclosure, the “resource” may be used interchangeably with a “resource for an arbitrary signal/channel” (e. g., a reference signal resource, an SRS resource, and the like). The resource may include time/frequency/code/space/power resource. The spatial domain transmission filter may include at least one of a spatial domain transmission filter and a spatial domain reception filter.

The group may include at least one of, for example, a spatial relationship group, a code division multiplexing (CDM) group, a reference signal (RS) group, a control resource set (CORESET) group, a PUCCH group, an antenna port group (for example, a DMRS port group), a layer group, a resource group, a beam group, an antenna group, a panel group, and the like.

In the present disclosure, a “beam”, an “SRS resource indicator (SRI)”, a “CORESET”, a “CORESET pool”, a “PDSCH”, a “PUSCH”, a “codeword (CW)”, a “transport block (TB)”, an “RS”, and the like may be interchangeably used.

In the present disclosure, a “TCI state”, a “downlink TCI state (DL TCI state)”, an “uplink TCI state (UL TCI state)”, a “unified TCI state”, a “common TCI state”, a “joint TCI state”, and the like may be used interchangeably.

In the present disclosure, “QCL”, “QCL assumption”, “QCL relationship”, “QCL type information”, “QCL property/properties”, “specific QCL type (e. g., type A, type D) property”, “specific QCL type (e. g., type A, type D)”, and the like may be used interchangeably.

In the present disclosure, an “index”, an “identifier (ID)”, an “indicator”, “indication”, a “resource ID”, and the like may be used interchangeably. In the present disclosure, a sequence, a list, a set, a group, a cluster, a subset, and the like may be used interchangeably.

A spatial relation information identifier (ID) (TCI state ID) and spatial relation information (TCI state) may be interchangeably used. “Spatial relation information (TCI state)” may be used interchangeably with “a set of spatial relation information (TCI state)”, “one or a plurality of spatial relation information”, and the like. The TCI state and the TCI may be used interchangeably. The spatial relation information and the spatial relation may be used interchangeably.

In the present disclosure, the terms such as a “base station (BS)”, a “radio base station”, a “fixed station,” a “NodeB”, an “ENB (eNodeB)”, a “qNB (gNodeB)”, an “access point”, a “transmission point (TP)”, a “reception point (RP)”, a “transmission/reception point (TRP)”, a “panel”, a “cell”, a “sector”, a “cell group”, a “carrier”, a “component carrier”, and so on can be used interchangeably. The base station may be referred to as the terms such as a “macro cell”, a “small cell”, a “femto cell”, a “pico cell”, and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, transmitting information to the terminal by the base station may be interchangeably interpreted as instructing the terminal to perform control/operation based on the information by the base station.

In the present disclosure, the terms “mobile station (MS)”, “user terminal”, “user equipment (UE)”, and “terminal” may be used interchangeably.

A Mobile Station May Be Referred to As a “subscriber station”, “mobile unit”, “subscriber unit”, “wireless unit”, “remote unit”, “mobile device”, “wireless device”, “wireless communication device”, “remote device”, “mobile subscriber station”, “access terminal”, “mobile terminal”, “wireless terminal”, “remote terminal” “handset”, “user agent”, “mobile client”, “client”, or some other appropriate terms in some cases.

At least one of a base station and a mobile station may be referred to as a “transmitting apparatus”, a “receiving apparatus”, a “radio communication apparatus” or the like. Note that at least one of a base station and a mobile station may be a device mounted on a moving object or a moving object itself, and so on.

The moving object is a movable object with any moving speed, and naturally, it also includes a moving object stopped. Examples of the moving object include a vehicle, a transport vehicle, an automobile, a motorcycle, a bicycle, a connected car, a loading shovel, a bulldozer, a wheel loader, a dump truck, a fork lift, a train, a bus, a trolley, a rickshaw, a ship and other watercraft, an airplane, a rocket, a satellite, a drone, a multicopter, a quadcopter, a balloon, and an object mounted on any of these, but these are not restrictive. The moving object may be a moving object that autonomously travels based on a direction for moving.

The moving object may be a vehicle (for example, a car, an airplane, and the like), may be a moving object which moves unmanned (for example, a drone, an automatic operation car, and the like), or may be a robot (a manned type or unmanned type).

Note that at least one of a base station and a mobile station also includes an apparatus which does not necessarily move during communication operation. For example, at least one of a base station and a mobile station may be an Internet of Things (IoT) device such as a sensor.

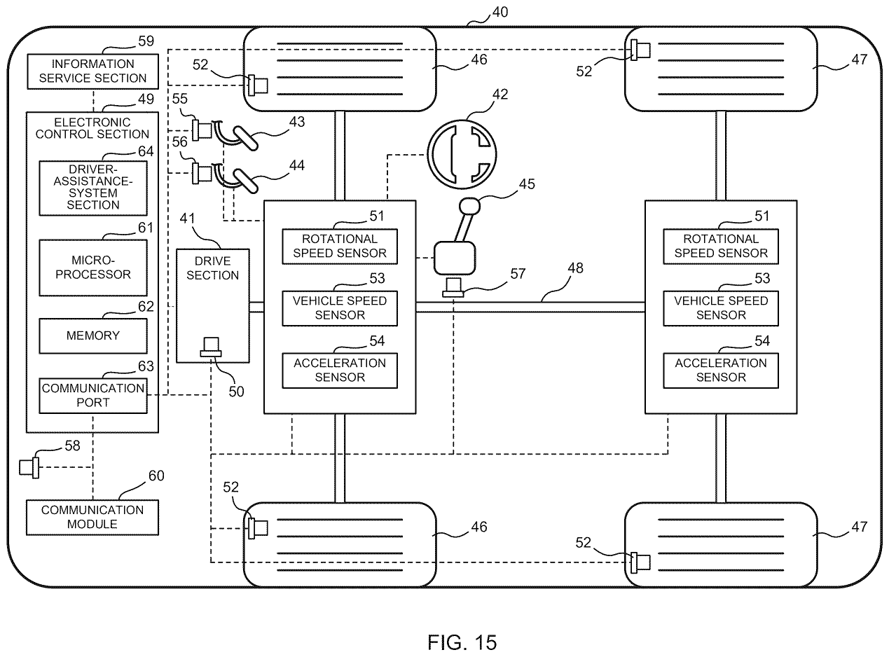

FIG. 15 is a diagram to show an example of a vehicle according to one embodiment. A vehicle 40 includes a driving section 41, a steering section 42, an accelerator pedal 43, a brake pedal 44, a shift lever 45, right and left front wheels 46, right and left rear wheels 47, an axle 48, an electronic control section 49, various sensors (including a current sensor 50, a rotational speed sensor 51, a pneumatic sensor 52, a vehicle speed sensor 53, an acceleration sensor 54, an accelerator pedal sensor 55, a brake pedal sensor 56, a shift lever sensor 57, and an object detection sensor 58), an information service section 59, and a communication module 60.

The driving section 41 includes, for example, at least one of an engine, a motor, and a hybrid of an engine and a motor. The steering section 42 includes at least a steering wheel (also referred to as a handle), and is configured to steer at least one of the front wheels 46 and the rear wheels 47, based on operation of the steering wheel operated by a user.

The electronic control section 49 includes a microprocessor 61, a memory (ROM, RAM) 62, and a communication port (for example, an input/output (IO) port) 63. The electronic control section 49 receives, as input, signals from the various sensors 50 to 58 provided in the vehicle. The electronic control section 49 may be referred to as an Electronic Control Unit (ECU).

Examples of the signals from the various sensors 50 to 58 include a current signal from the current sensor 50 for sensing current of a motor, a rotational speed signal of the front wheels 46/rear wheels 47 acquired by the rotational speed sensor 51, a pneumatic signal of the front wheels 46/rear wheels 47 acquired by the pneumatic sensor 52, a vehicle speed signal acquired by the vehicle speed sensor 53, an acceleration signal acquired by the acceleration sensor 54, a depressing amount signal of the accelerator pedal 43 acquired by the accelerator pedal sensor 55, a depressing amount signal of the brake pedal 44 acquired by the brake pedal sensor 56, an operation signal of the shift lever 45 acquired by the shift lever sensor 57, and a detection signal for detecting an obstruction, a vehicle, a pedestrian, and the like acquired by the object detection sensor 58.

The information service section 59 includes: various devices for providing (outputting) various pieces of information such as driving information, traffic information, and entertainment information, such as a car navigation system, an audio system, a speaker, a display, a television, and a radio; and one or more ECUs that control these devices. The information service section 59 provides various pieces of information/services (for example, multimedia information/multimedia service) to an occupant of the vehicle 40, using information acquired from an external apparatus via the communication module 60 and the like.

The information service section 59 may include an input device (for example, a keyboard, a mouse, a microphone, a switch, a button, a sensor, a touch panel, and the like) for receiving input from the outside, or may include an output device (for example, a display, a speaker, an LED lamp, a touch panel, and the like) for implementing output to the outside.

A driving assistance system section 64 includes: various devices for providing functions for preventing an accident and reducing a driver's driving load, such as a millimeter wave radar, Light Detection and Ranging (LIDAR), a camera, a positioning locator (for example, a Global Navigation Satellite System (GNSS) and the like), map information (for example, a high definition (HD) map, an autonomous vehicle (AV) map, and the like), a gyro system (for example, an inertial measurement apparatus (inertial measurement unit (IMU)), an inertial navigation apparatus (inertial navigation system (INS)), and the like), an artificial intelligence (AI) chip, and an AI processor; and one or more ECUS that control these devices. The driving assistance system section 64 transmits and receives various pieces of information via the communication module 60, and implements a driving assistance function or an autonomous driving function.

The communication module 60 can communicate with the microprocessor 61 and the constituent elements of the vehicle 40 via the communication port 63. For example, the communication module 60 transmits and receives data (information), via the communication port 63, to and from the driving section 41, the steering section 42, the accelerator pedal 43, the brake pedal 44, the shift lever 45, the right and left front wheels 46, the right and left rear wheels 47, the axle 48, the microprocessor 61 and the memory (ROM, RAM) 62 in the electronic control section 49, and the various sensors 50 to 58, which are included in the vehicle 40.

The communication module 60 is a communication device that can be controlled by the microprocessor 61 of the electronic control section 49 and that can perform communication with an external apparatus. For example, the communication module 60 performs transmission and reception of various pieces of information to and from the external apparatus via radio communication. The communication module 60 may be either inside or outside the electronic control section 49. The external apparatus may be, for example, the base station 10, the user terminal 20, or the like described above. The communication module 60 may be, for example, at least one of the base station 10 and the user terminal 20 described above (may function as at least one of the base station 10 and the user terminal 20).

The communication module 60 may transmit at least one of signals input from the various sensors 50 to 58 to the electronic control section 49, information obtained based on the signals, and information based on an input from the outside (a user) obtained via the information service section 59, to the external apparatus via radio communication. The electronic control section 49, the various sensors 50 to 58, the information service section 59, and the like may be referred to as input sections that receive input. For example, the PUSCH transmitted by the communication module 60 may include information based on the input.

The communication module 60 receives various pieces of information (traffic information, signal information, inter-vehicle distance information, and the like) transmitted from the external apparatus, and displays the received information on the information service section 59 included in the vehicle. The information service section 59 may be referred to as an output section that outputs information (for example, outputs information to devices, such as a display and a speaker, based on the PDSCH received by the communication module 60 (or data/information decoded from the PDSCH)).

The communication module 60 stores the various pieces of information received from the external apparatus in the memory 62 that can be used by the microprocessor 61. Based on the pieces of information stored in the memory 62, the microprocessor 61 may control the driving section 41, the steering section 42, the accelerator pedal 43, the brake pedal 44, the shift lever 45, the right and left front wheels 46, the right and left rear wheels 47, the axle 48, the various sensors 50 to 58, and the like provided in the vehicle 40.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D)”, “Vehicle-to-Everything (V2X)”, and the like). In this case, user terminals 20 may have the functions of the base stations 10 described above. The words such as “uplink” and “downlink” may be interpreted as the words corresponding to the terminal-to-terminal communication (for example, “sidelink”). For example, an uplink channel, a downlink channel and so on may be interpreted as a sidelink channel.

Likewise, the user terminal in the present disclosure may be interpreted as a base station. In this case, the base station 10 may have the functions of the user terminal 20 described above.

Operations which have been described in the present disclosure to be performed by a base station may, in some cases, be performed by an upper node of the base station. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

Each aspect/embodiment described in the present disclosure may be used independently, may be used in combination, or may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG (where x is, for example, an integer or a decimal)), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods and next-generation systems that are enhanced, modified, created, or defined based on these. A plurality of systems may be combined (for example, a combination of LTE or LTE-A and 5G, and the like) for application.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first”, “second”, and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “deciding (determining)” as in the present disclosure herein may encompass a wide variety of actions. For example, “deciding (determining)” may be interpreted to mean making “decisions (determinations)” about judging, calculating, computing, processing, deriving, investigating, looking up, search and inquiry (for example, searching a table, a database, or some other data structures), ascertaining, and so on.

Furthermore, “deciding (determining)” may be interpreted to mean making “decisions (determinations)” about receiving (for example, receiving information), transmitting (for example, transmitting information), input, output, accessing (for example, accessing data in a memory), and so on.

In addition, “deciding (determining)” as used herein may be interpreted to mean making “decisions (determinations)” about resolving, selecting, choosing, establishing, comparing, and so on. In other words, “deciding (determining)” may be interpreted to mean making “decisions (determinations)” about some action. In the present disclosure, “decide/deciding (determine/determining)” may be interchangeably interpreted as the above-described actions.

In the present disclosure, “decide/deciding (determine/determining)” may be used interchangeably with “assume/assuming”, “expect/expecting”, “consider/considering”, and the like. Note that, in the present disclosure, “not expect to” may be used interchangeably with “expect not to”.

In the present disclosure, “expect” may be used interchangeably with “be expected”. For example, “expect(s) . . . ” (“. . . ” may be expressed using, for example, a that-clause, a to-infinitive, or the like) may be used interchangeably with “be expected . . .”. “Does not expect . . . ” may be used interchangeably with “be not expected . . . ”. Furthermore, “an apparatus A is not expected . . . ” may be used interchangeably with “an apparatus B other than the apparatus A does not expect . . . for the apparatus A” (for example, when the apparatus A is a UE, the apparatus B may be a base station).

“The maximum transmit power” described in the present disclosure may mean a maximum value of the transmit power, may mean the nominal maximum transmit power (the nominal UE maximum transmit power), or may mean the rated maximum transmit power (the rated UE maximum transmit power).

The terms “connected”, “coupled”, or any variation of these terms as used in the present disclosure mean any direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access”.

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other”. It should be noted that the phrase may mean that “A and B are each different from C”. The terms “separate”, “coupled”, and so on may be interpreted similarly to “different”.

In the case where the terms “include”, “including”, and variations thereof are used in the present disclosure, these terms are intended to be comprehensive, in a manner similar to the term “comprising”. Furthermore, the term “or” used in the present disclosure is not intended to be an “exclusive or”.

For example, in the present disclosure, where an article such as “a”, “an”, and “the” is added by translation, the present disclosure may include that a noun after the article is in a plural form.

In the present disclosure, “equal to or less than”, “less than”, “equal to or more than”, “more than”, “equal to”, and the like may be used interchangeably. In the present disclosure, words such as “good”, “bad”, “large”, “small”, “high”, “low”, “early”, “late”, “wide”, “narrow”, and the like may be used interchangeably irrespective of positive degree, comparative degree, and superlative degree. In the present disclosure, expressions obtained by adding “i-th” (i is any integer) to words such as “good”, “bad”, “large”, “small”, “high”, “low”, “early”, “late”, “wide”, “narrow”, and the like may be used interchangeably irrespective of positive degree, comparative degree, and superlative degree (for example, “best” may be used interchangeably with “i-th best”, and vice versa).

In the present disclosure, “of”, “for”, “regarding”, “related to”, “associated with”, and the like may be used interchangeably.

In the present disclosure, “when A, B”, “if A, (then) B”, “B upon A”, “B in response to A”, “B based on A”, “B during/while A”, “B before A”, “B (at the same time as)/on A”, “B after A”, “B since A”, “B until A”, and the like may be used interchangeably. Note that A and B here may be replaced with appropriate expressions such as nouns, dynamic nouns, and normal sentences, as appropriate, depending on the context. The time difference between A and B may be substantially 0 (immediately after or immediately before). A time offset may be applied to the time at which A occurs. For example, “A” may be used interchangeably with “before/after the time offset at which A occurs”. The time offset (for example, one or more symbols/slots) may be defined in advance or may be specified by the UE based on the notified information.

In the present disclosure, timing, time point, time, time instance, any time unit (e.g., slot, sub-slot, symbol, subframe), period, occasion, a resource, or the like may be used interchangeably.

Now, although the invention according to the present disclosure has been described in detail above, it is apparent to a person skilled in the art that the invention according to the present disclosure is by no means limited to the embodiments described in the present disclosure. The description of the present disclosure is provided only for the purpose of explaining examples, and should by no means be construed to limit the invention according to the present disclosure in any way.

1.-6. (canceled)

7. A terminal comprising:
a receiver that receives downlink control information (DCI) used for scheduling of a physical uplink shared channel (PUSCH); and
a processor that, when a number of layers indicated by the DCI is larger than 4, determines that a value of a field related to presence or absence of uplink shared channel (UL-SCH) transmission included in the DCI is not 0.

8. The terminal according to claim 7, wherein when the DCI is a specific DCI format and the number of layers is larger than 4, the processor determines that the value of the field is not 0.

9. A radio communication method for a terminal, comprising:
receiving downlink control information (DCI) used for scheduling of a physical uplink shared channel (PUSCH); and
when a number of layers indicated by the DCI is larger than 4, determining that a value of a field related to presence or absence of uplink shared channel (UL-SCH) transmission included in the DCI is not 0.

10. A base station comprising:
a transmitter that transmits downlink control information (DCI) used for scheduling of a physical uplink shared channel (PUSCH); and
a processor that, when indicating, using the DCI, a number of layers larger than 4, determines that a value of a field related to presence or absence of uplink shared channel (UL-SCH) transmission included in the DCI is not 0.

11. A system comprising a terminal and a base station, wherein
the terminal comprises:
a receiver that receives downlink control information (DCI) used for scheduling of a physical uplink shared channel (PUSCH); and
a processor that, when a number of layers indicated by the DCI is larger than 4, determines that a value of a field related to presence or absence of uplink shared channel (UL-SCH) transmission included in the DCI is not 0, and
the base station comprises:
a transmitter that transmits the DCI.
